(19) United States
(12) Patent Application Publication
(10) Pub. No.: US 2019/0075460 A1
(43) Pub. Date: Mar. 7, 2019

(54) AUTHENTICATION SYSTEM, AUTHENTICATION CONTROL DEVICE, METHOD OF CONTROLLING AUTHENTICATION CONTROL DEVICE, AND RECORDING MEDIUM

(71) Applicant: KONICA MINOLTA, INC., Tokyo (JP)

(72) Inventors: Kenji SAKAMOTO, Nishinomiya-shi (JP); Kenichi NAGASAWA, Osaka (JP)

(73) Assignee: KONICA MINOLTA, INC., Tokyo (JP)

(21) Appl. No.: 16/118,347

(22) Filed: Aug. 30, 2018

(30) Foreign Application Priority Data
Sep. 1, 2017 (JP) 2017-168588

(51) Int. Cl. H04W 12/06; G06K 9/00; H04N 1/44; H04W 8/00; H04L 29/06

(52) U.S. Cl. CPC H04W 12/06; G06K 9/00892; H04L 63/0861; H04N 1/4426; H04W 8/005; H04N 1/442

(57) ABSTRACT

An authentication system for performing biometric authentication through one-to-many authentication includes a biological information reader that reads biological information on a to-be-authenticated user as input information for the one-to-many authentication, a detector that detects a nearby terminal that is a mobile terminal present in close proximity to the biological information reader among a plurality of mobile terminals carried respectively by a plurality of users, and a hardware processor that determines at least one piece of biological information registered in association with each user of at least one mobile terminal each detected as the nearby terminal among a plurality of pieces of biological information registered in advance as candidates for check target information for the one-to-many authentication, as the check target information that is information targeted for processing for checking against the input information for the one-to-many authentication.

Japanese Patent Application No. 2017-168588 filed on Sep. 1, 2017, including description, claims, drawings, and abstract the entire disclosure is incorporated herein by reference in its entirety.

### BACKGROUND

### Technological Field

The present invention relates to an authentication system for performing biometric authentication, and techniques related thereto.

### Description of the Related Art

There are techniques for classifying a plurality of users registered in an authentication system into a plurality of groups, enabling selection by a to-be-authenticated user of a group to which he or she belongs, and then performing biometric authentication through one-to-many authentication, which will be described in detail later.

For example, with the technique disclosed in Japanese Patent Application Laid-Open No. 2008-204205, the to-be-authenticated user selects the group to which he or she belongs from among a plurality of groups during biometric authentication through one-to-many authentication. Then, pieces of biological information on users who belong to the group selected by the to-be-authenticated user are extracted as the check target information for one-to-many authentication (information targeted for processing for checking against input information for one-to-many authentication) from among a plurality of pieces of biological information registered in advance in the authentication system, and biometric authentication through one-to-many authentication is performed. According to this technique, the check target information for one-to-many authentication is narrowed down to biological information on users who belong to the group to which the to-be-authenticated user belongs, and therefore it is possible to, for example, reduce the time required to perform biometric authentication.

However, selecting groups to which users belong during biometric authentication through one-to-many authentication is a burdensome operation for the users.

Alternatively, a technique for enabling selection by a to-be-authenticated user of a group to which he or she belongs and then performing biometric authentication through one-to-one authentication, which will be described in detail later, is also conceivable.

Specifically, the to-be-authenticated user selects the group to which he or she belongs from among a plurality of groups during biometric authentication through one-to-one authentication. In response to the operation of the to-be-authenticated user selecting the group to which he or she belongs, a user list consisting of users in one group selected from among a plurality of registered users by the to-be-authenticated user is generated and displayed as a user list (user designation list) for designating one user who corresponds to check target information for one-to-one authentication. Then, the to-be-authenticated user extracts biological information (a piece of biological information) on one user designated from the user designation list as the check target information, and biometric authentication through one-to-one authentication is performed. According to this technique, the user list consisting of users who belong to the group to which the to-be-authenticated user belongs is displayed as the user designation list, and therefore the to-be-authenticated user is able to more easily find out and select the one user than in the case where a user list consisting of all registered users is displayed as the user designation list.

Even with this technique, it is a burdensome operation for the to-be-authenticated user to select the group to which he or she belongs during biometric authentication through one-to-one authentication.

### SUMMARY

It is an object of the present invention to provide a technique that allows savings in time and effort to select groups to which users belong during biometric authentication.

A first aspect of the present invention is an authentication system for performing biometric authentication through one-to-many authentication. The authentication system includes a biological information reader that reads biological information on a to-be-authenticated user as input information for the one-to-many authentication, a detector that detects a nearby terminal among a plurality of mobile terminals carried respectively by a plurality of users, the nearby terminal being a mobile terminal present in close proximity to the biological information reader, and a hardware processor that determines at least one piece of biological information among a plurality of pieces of biological information registered in advance as candidates for check target information for the one-to-many authentication, as the check target information, the at least one piece of biological information being registered in association with each user of at least one mobile terminal each detected as the nearby terminal, the check target information being information targeted for check processing for checking against the input information for the one-to-many authentication.

A second aspect of the present invention is an authentication system for performing biometric authentication through one-to-one authentication. The authentication system includes a biological information reader that reads biological information on a to-be-authenticated user as input information for the one-to-one authentication, a detector that detects a nearby terminal among a plurality of mobile terminals carried respectively by a plurality of users, the nearby terminal being a mobile terminal present in close proximity to the biological information reader, and a hardware processor that generates a user designation list that is a user list used to designate one user who corresponds to check target information that is information targeted for processing for checking against the input information for the one-to-one authentication. The hardware processor generates, as the user designation list, a user list consisting of each user of at least one mobile terminal, each detected as the nearby terminal, among a plurality of registered users in the authentication system.

A third aspect of the present invention is an authentication control device for use in an authentication system for performing biometric authentication through one-to-many authentication. The authentication control device includes a hardware processor that acquires biological information that is regarding a to-be-authenticated user and that is read by a biological information reader as input information for the one-to-many authentication, identifies each user of at least one mobile terminal, each detected as a nearby terminal by detection processing for detecting the nearby terminal that is a mobile terminal present in close proximity to the biological information reader, among a plurality of mobile terminals carried respectively by a plurality of users, and determines check target information that is information targeted for processing for checking against the input information for the one-to-many authentication. The hardware processor determines, as the check target information, at least one piece of biological information that is registered in association with the each user of the at least one mobile terminal, each detected as the nearby terminal, among a plurality of pieces of biological information registered in advance as candidates for the check target information for the one-to-many authentication.

A fourth aspect of the present invention is an authentication control device for use in an authentication system for performing biometric authentication through one-to-one authentication. The authentication control device includes a hardware processor that acquires biological information that is regarding a to-be-authenticated user and that is read by a biological information reader as input information for the one-to-one authentication, identifies each user of at least one mobile terminal, each detected as a nearby terminal by detection processing for detecting the nearby terminal that is a mobile terminal present in close proximity to the biological information reader, among a plurality of mobile terminals carried respectively by a plurality of users, and generates a user designation list that is a user list used to designate one user who corresponds to check target information that is information targeted for processing for checking against the input information for the one-to-one authentication. The hardware processor generates, as the user designation list, a user list consisting of the each user of the at least one mobile terminal each detected as the nearby terminal among a plurality of registered users in the authentication system.

A fifth aspect of the present invention is a method of controlling an authentication control device for use in an authentication system for performing biometric authentication through one-to-many authentication. The method includes a) acquiring biological information that is regarding a to-be-authenticated user and that is read by a biological information reader as input information for the one-to-many authentication, b) identifying each user of at least one mobile terminal, each detected as a nearby terminal by detection processing for detecting the nearby terminal that is a mobile terminal present in close proximity to the biological information reader, among a plurality of mobile terminals carried respectively by a plurality of users, and c) determining check target information that is information targeted for processing for checking against the input information for the one-to-many authentication.

In the step c), at least one piece of biological information that is registered in association with the each user of the at least one mobile terminal, each detected as the nearby terminal, among a plurality of pieces of biological information registered in advance as candidates for the check target information for the one-to-many authentication is determined as the check target information.

A sixth aspect of the present invention is a method of controlling an authentication control device for use in an authentication system for performing biometric authentication through one-to-one authentication. The method includes a) acquiring biological information that is regarding a to-be-authenticated user and that is read by a biological information reader as input information for the one-to-one authentication, b) identifying each user of at least one mobile terminal, each detected as a nearby terminal by detection processing for detecting the nearby terminal that is a mobile terminal present in close proximity to the biological information reader, among a plurality of mobile terminals carried respectively by a plurality of users, and c) generating a user designation list that is a user list used to designate one user who corresponds to check target information that is information targeted for processing for checking against the input information for the one-to-one authentication. In the step c), a user list consisting of the each user of the at least one mobile terminal each detected as the nearby terminal among a plurality of registered users in the authentication system is generated as the user designation list.

A seventh aspect of the present invention is a non-transitory computer-readable recording medium that records a program for causing a computer to execute the control method according to the fifth aspect, the computer controlling the authentication control device.

An eighth aspect of the present invention is a non-transitory computer-readable recording medium that records a program for causing a computer to perform the control method according to the sixth aspect, the computer controlling the authentication control device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an authentication system.

FIG. 2 illustrates functional blocks of an image forming apparatus (MFP).

FIG. 3 is a functional block diagram illustrating a schematic configuration of an authentication server.

FIG. 4 illustrates a biological information management table.

FIG. 5 is a conceptual diagram illustrating operations performed in the authentication system.

FIG. 6 is a flowchart of operations of the MFP.

FIG. 7 is a flowchart of operations of the authentication server.

FIG. 8 illustrates a finger placement request screen.

FIG. 9 illustrates a group selection screen.

FIG. 10 illustrates a top menu screen.

FIG. 11 illustrates an authentication failure notification screen.

FIG. 12 is a functional block diagram illustrating a schematic configuration of an authentication server according to a second embodiment.

FIG. 13 is a flowchart of operations of the MFP according to the second embodiment.

FIG. 14 is a flowchart of operations of the authentication server according to the second embodiment.

FIG. 15 illustrates a user designation list screen to be displayed in the case where nearby terminals have been detected.

FIG. 16 illustrates a user designation list screen to be displayed in the case where no nearby terminals have been detected.

FIG. 17 is a flowchart of operations of the MFP according to a first modified example of the first embodiment.

FIG. 18 illustrates a terminal-carrying confirmation screen.

FIG. 19 is a flowchart of operations of the MFP according to a first modified example of the second embodiment.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

### 1-1. Overall Configuration

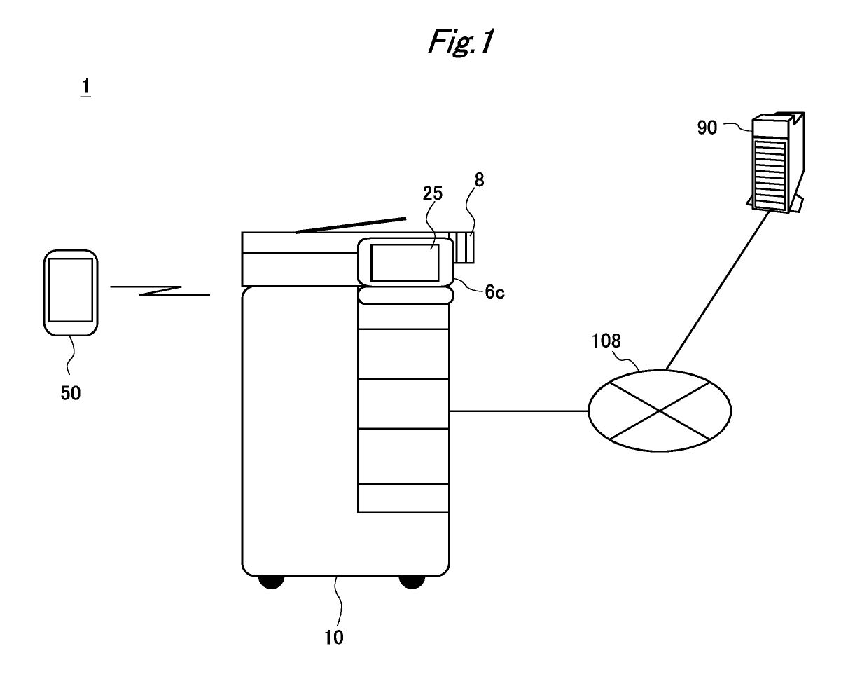

FIG. 1 illustrates an authentication system 1 according to the present invention. As illustrated in FIG. 1, the authentication system 1 includes a Multi-Functional Peripheral (MFP) 10, an authentication server 90, and a mobile terminal 50.

The MFP 10 and the authentication server 90 are communicably connected to each other via a network 108. The network 108 is configured by, for example, a local area network (LAN) and the Internet. The form of connection to the network 108 may be wired connection or wireless connection.

The MFP 10 and the mobile terminal 50 are wirelessly connected to each other using wireless communication techniques of various types. For example, short-distance wireless communication can be used for communication between the MFP 10 and the mobile terminal 50. In the present embodiment, communication

(BLE communication) based on Bluetooth Low Energy (BLE), which is an extended standard for Bluetooth (registered trademark), is used as short-distance communication so as to allow wireless communication between the mobile terminal 50 and the MFP 10. Note that the communication between the MFP 10 and the mobile terminal 50 may be bidirectional communication or may be unidirectional communication (one-way communication).

The mobile terminal 50 is an information input/output terminal device (information device) capable of emitting radio waves for short-distance communication (here, BLE communication). One mobile terminal 50 is given to each of a plurality of users (registered users) in this authentication system 1. Also, each user ordinarily moves in a room while carrying his or her own mobile terminal 50 (the user who carries a mobile terminal is also referred to as a “mobile-terminal carrying user”). Here, a smartphones is given as an example of the mobile terminal 50. The mobile terminal 50 is, however, not limited to this example and may be other devices such as a tablet terminal. As another alternative, the mobile terminal 50 may be a wrist-band type (wrist-wearable) device.

The authentication system 1 adopts biometric authentication (rather than password authentication involving the operation of inputting user IDs and passwords) as login authentication performed in the case where the MFP 10 is used.

The biometric authentication is authentication processing for authenticating (identifying) individuals on the basis of human biological features (e.g., biological information such as fingerprints). The biometric authentication includes authentication using static biological information on a to-be-authenticated user as authentication information (which is also referred to as “static biometric authentication”) and authentication using dynamic biological information on a to-be-authenticated user as authentication information (which is also referred to as “dynamic biometric authentication”). Examples of the static biometric authentication include fingerprint authentication using the fingerprints of, for example, human fingers, iris authentication using radial patterns of irises of human eyes, facial authentication using features of human faces (e.g., shapes and positions of, for example, eyes and noses, and contours), and vein authentication using vein information (vein patterns) on, for example, human fingers. Examples of the dynamic biometric authentication include pulse authentication using human pulse information (pulse patterns). Here, fingerprint authentication is adopted as biometric authentication. The present invention is, however, not limited to this example, and other types of biometric authentication (or both fingerprint authentication and other types of biometric authentication) may be adopted.

The authentication system 1 according to the first embodiment adopts biometric authentication through one-to-many authentication (also referred to as “one-to-N authentication”).

The one-to-many authentication is an authentication technique for performing check processing for checking input information (biological information on a to-be-authenticated user) against check target information (at least one piece of biological information registered in advance) without involving a designation operation of designating one user who corresponds to the check target information (information targeted for the check processing for checking against the input information). The one-to-many authentication is thus also referred to as “user designation-free authentication.”

Note that there is one-to-one authentication as an authentication technique different from the one-to-many authentication (see a second embodiment). The one-to-one authentication is an authentication technique for receiving a designation operation of designating one user who corresponds to check target information and then performing check processing for checking input information (biological information on a to-be-authenticated user) against the check target information (one piece of biological information that corresponds to one user designated by the designation operation among a plurality of pieces of biological information registered in advance). In short, the one-to-one authentication is an authentication technique that involves the designation of a user who corresponds to the check target information, and is thus also referred to as “user designation-involving authentication.”

Here, the biometric authentication through one-to-many authentication is expressed as one-to-many authentication because it is an authentication technique that often uses biological information on a “plurality of” users as information on check targets (check target information) that are used to check against input information (biological information on a to-be-authenticated user) (and also because of the need to be contrasted with the “one-to-one authentication”). However, the check target information for the one-to-many authentication does not necessarily have to be information on a plurality of users, and may be information on a single user. In particular, in the first embodiment and other embodiments and variations of the present invention, the check target information for the one-to-many authentication may become biological information on a single user as a result of being narrowed down to biological information on some users (a relatively small number of users) among all registered users by using a technique different from the “designation of a user” (e.g., processing for detecting nearby terminals, which will be described later). In that case, the biological information (input information) on the to-be-authenticated user may be checked against the narrowed-down biological information (check target information) on the single user.

In this way, the “biometric authentication through one-to-many authentication” is a biometric authentication technique for performing check processing for checking the input information against the check target information (at least one piece of biological information registered in advance) without involving the designation operation of designating one user (to-be-authenticated user) who corresponds to the check target information.

In the fingerprint authentication through one-to-many authentication, when the to-be-authenticated user places his or her finger on a predetermined position where a sensor or the like for reading fingerprints (e.g., a biological information reader 8 of the MFP 10; see FIG. 1) is embedded, fingerprint information on that finger is read as input information (check source information) for one-to-many authentication. Thereafter, fingerprint authentication is performed by checking (comparing) the input information for one-to-many authentication (fingerprint information on the to-be-authenticated user) against (with) the check target information for one-to-many authentication (at least one piece of fingerprint information registered in advance in the authentication system 1). If the check target information includes one piece of fingerprint information that matches with the fingerprint information on the to-be-authenticated user at a predetermined level or more in the fingerprint authentication, the fingerprint authentication is determined to have succeeded, and the to-be-authenticated user is identified as one user registered in association with the one piece of fingerprint information. On the other hand, if the check target information does not include any piece of fingerprint information that matches with the fingerprint information on the to-be-authenticated user at a predetermined level or more, the fingerprint authentication is determined to have failed.

In this authentication system 1, a plurality of registered users (here, 5000 users) is classified into a plurality of groups (units) (here, 10 groups). In other words, the authentication system 1 includes a plurality of groups, each consisting of a predetermined number of (e.g., 500) users, and each of the registered users belongs to one of the groups.

### 2. Configuration of MFP 10

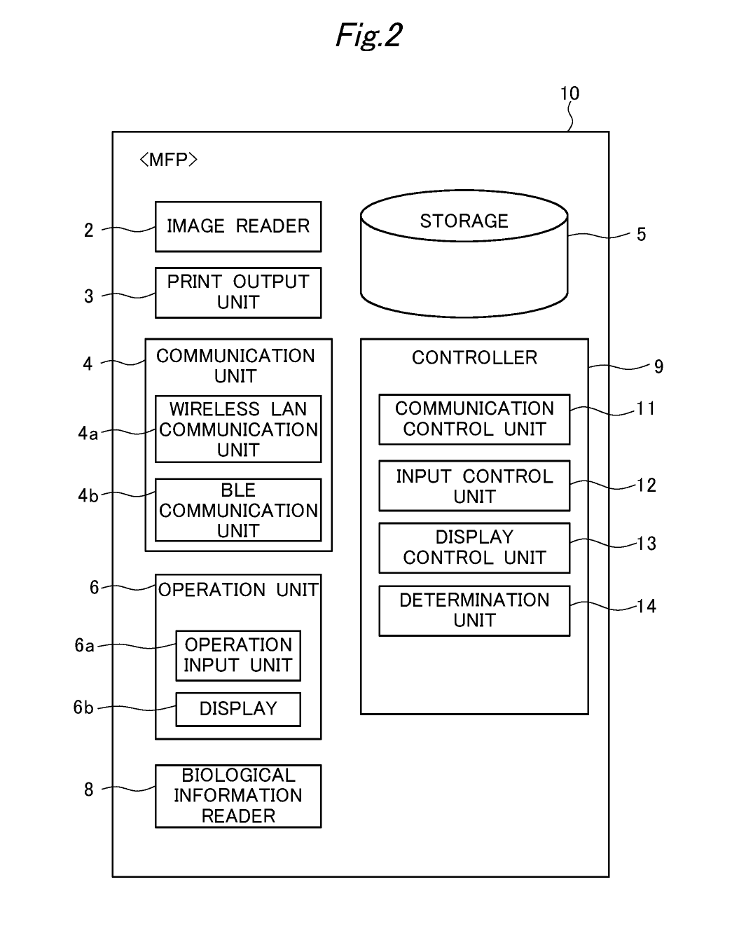

FIG. 2 illustrates functional blocks of the MFP 10.

The MFP 10 is an apparatus (also referred to as a “Multi-Functional Peripheral) having functions such as a scan function, a copy function, a facsimile function, and a box storage function. Specifically, the MFP 10 includes, for example, an image reader 2, a print output unit 3, a communication unit 4, a storage 5, an operation unit 6, and a controller 9 as illustrated in the functional block diagram in FIG. 2, and implements various types of functions by operating these units in combination. Note that the MFP 10 is also referred to as an image processing apparatus or an image forming apparatus.

The image reader 2 is a processing unit that optically reads (i.e., scans) an original document placed at a predetermined position on the MFP 10 and generates image data of the original document (also referred to as an “original image” or a “scanned image”).

The print output unit 3 is an output unit that prints out an image on various types of media such as paper on the basis of data regarding an object to be printed.

The communication unit 4 is a processing unit capable of facsimile communication via, for example, a public network. The communication unit 4 is also capable of various types of wireless communication (including BLE wireless communication, for example). Specifically, the communication unit 4 includes a wireless LAN communication unit 4a that carries out wireless communication via a wireless LAN (e.g., IEEE 802.11) and a BLE communication unit 4b that carries out wireless communication via BLE. The BLE communication unit 4b receives radio waves for short-distance wireless communication (BLE communication), transmitted from the mobile terminal 50 and measures the intensity of the radio waves. The BLE communication unit 4b performs processing for detecting nearby terminals, which will be described later, on the basis of the measured intensity of the radio waves. Specifically, the BLE communication unit 4b detects a mobile terminal 50 (also referred to as a nearby terminal) that is present in close proximity to the biological information reader 8 among a plurality of mobile terminals 50 that a plurality of users respectively carry, on the basis of the intensity of the radio waves (radio waves for BLE communication) between the BLE communication unit 4b and each mobile terminal 50. Here, the BLE communication unit 4b is provided in close proximity to the biological information reader 8. The present invention is, however, not limited to this example, and the BLE communication unit 4b may be provided inside the biological information reader 8.

The storage 5 is configured by storage devices such as a hard disk drive (HDD) and semiconductor memories.

The operation unit 6 includes an operation input unit 6a that receives input of operations made to the MFP 10, and a display 6b that displays and outputs various types of information.

The MFP 10 is provided with a generally plate-like operation panel unit 6c (see FIG. 1). The operation panel unit 6c has a touch panel 25 (see FIG. 1) on the front side. The touch panel 25 functions not only as part of the operation input unit 6a but also as part of the display 6b. The touch panel 25 is configured by embedding, for example, various types of sensors in a liquid crystal display panel and is capable of displaying various types of information and receiving input of various types of operations from an operating user.

The biological information reader 8 is a processing unit capable of reading biological information (here, fingerprint information) on a to-be-authenticated user. The biological information reader 8 has embedded therein, for example, a sensor for reading the fingerprints of persons and uses this sensor to read fingerprint information on the to-be-authenticated user.

The controller 9 is a control device that is built in the MFP 10 and performs overall control of the MFP 10. The controller 9 is configured as a computer system that includes, for example, a central processing unit (CPU; also referred to as a microprocessor or a computer processor) and various types of semiconductor memories (RAMS and ROMs). The controller 9 implements various types of processing units by causing the CPU to execute predetermined software programs (hereinafter, also simply referred to as “programs”) stored in a ROM (e.g., EEPROM; registered trademark). Note that the programs (to be more specific, a group of program modules) may be recorded in a portable recording medium such as an USB memory (in other words, any of various types of non-transitory computer-readable recording media) and may be read from the recording medium and installed into the MFP 10. Alternatively, these programs may be downloaded via, for example, the network 108 and installed into the MFP 10.

Specifically, as illustrated in FIG. 2, the controller 9 implements various types of processing units including a communication control unit 11, an input control unit 12, a display control unit 13, and a determination unit 14 by executing the programs.

The communication control unit 11 is a processing unit that controls operations of communication with other devices (e.g., authentication server 90) in cooperation with, for example, the communication unit 4. The communication control unit 11 includes a transmission control unit that controls operations of transmitting various types of data, and a reception control unit that controls operations of receiving various types of data. For example, the communication control unit 11 transmits biological information (fingerprint information) on the to-be-authenticated user to the authentication server 90 in cooperation with the communication unit 4. The communication control unit 11 also receives an authentication result (result of determination as to whether the authentication has succeeded or failed) of the biometric authentication performed by the authentication server 90 from the authentication server 90 in cooperation with the communication unit 4.

The input control unit 12 is a control unit that controls operations of receiving input of operations made through the operation input unit 6a (e.g., touch panel 25). For example, the input control unit 12 controls operations of receiving input of operations made through an operation screen displayed on the touch panel 25.

The display control unit 13 is a processing unit that controls operations of display on the display 6b (e.g., touch panel 25).

The determination unit 14 is a processing unit that performs various types of determination operations.

Here, although description is given using an example of a mode in which the aforementioned various types of operations are primarily performed by the CPU of the controller 9 executing software programs, the present invention is not limited to this example, and the aforementioned various types of operations may be performed using, for example, dedicated hardware provided in the MFP 10 (to be specific, inside or outside the controller 9). For example, all or some of the units such as the communication control unit 11, the input control unit 12, the display control unit 13, and the determination unit 14 (FIG. 2) may be implemented by a single piece or a plurality of pieces of dedicated hardware.

### 1-3. Configuration of Authentication Server 90

Next, the configuration of the authentication server 90 will be described.

The authentication server 90 is a server device (external server device) capable of performing biometric authentication (here, biometric authentication through one-to-many authentication). The authentication server 90 is also referred to as an authentication control device.

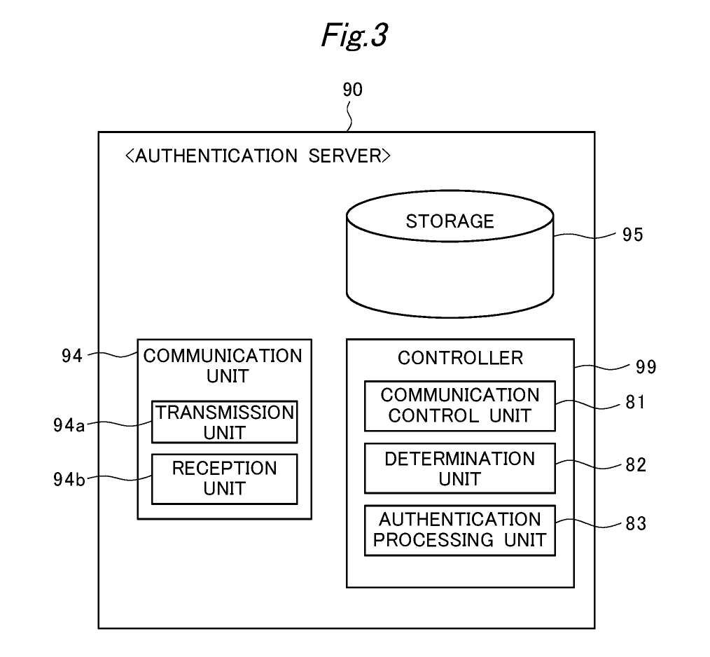

FIG. 3 is a functional block diagram illustrating a schematic configuration of the authentication server 90.

As illustrated in the functional block diagram in FIG. 3, the authentication server 90 includes, for example, a communication unit 94, a storage 95, and a controller 99 (controller) and implements various types of functions by operating these units in combination.

The communication unit 94 is capable of network communication via the network 108. This network communication uses, for example, various types of protocols such as TCP/IP (Transmission Control Protocol/Internet Protocol). Using the network communication allows the authentication server 90 to exchange various types of data with desired devices (e.g., MFP 10). The communication unit 94 includes a transmission unit 94a that transmits various types of data and a reception unit 94b that receives various types of data.

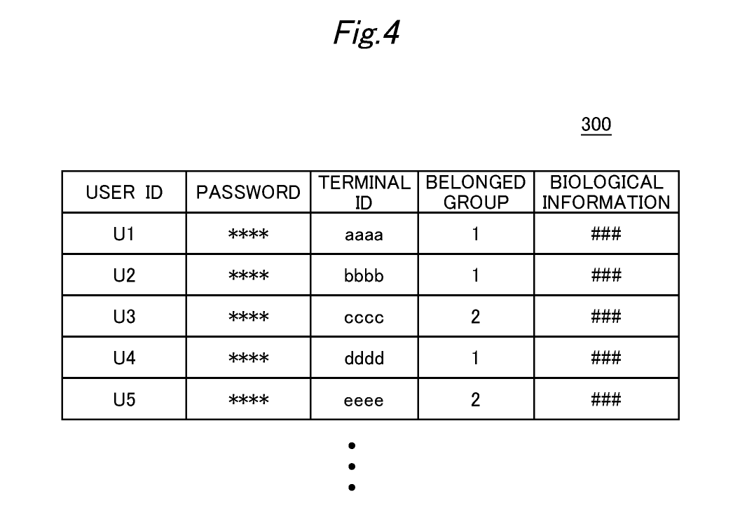

The storage 95 is configured by various types of storage devices (e.g., volatile and/or nonvolatile semiconductor memories and/or a hard disk drive (HDD)). For example, the storage 95 of the authentication server 90 stores a biological information management table 300 (FIG. 4).

In the biological information management table 300, authorized biological information (a plurality of pieces of biological information) on each of a plurality of registered users is registered in advance in association respectively with each of the plurality of registered users, as candidates for check target information for one-to-many authentication (information targeted for processing for checking against input information for one-to-many authentication). Specifically, in the biological information management table 300, user identification information (user IDs), passwords, terminal identification information (terminal IDs of the mobile terminals 50 of the registered users), groups to which registered users belong, and biological information (authorized biological information) are registered in association with each of a plurality of registered users (e.g., 5000 users). For example, information registered in association with a user U1 includes a user ID (“user U1”), a password, a terminal ID (terminal ID “aaaa” of a mobile terminal 50a of the user U1), a group (“group 1”) to which the user U1 belongs, and authorized biological information on the user U1.

The controller 99 is a control device that is built in the authentication server 90 and performs overall control of the authentication server 90. The controller 99 is configured as a computer system that includes, for example, a CPU and various types of semiconductor memories (RAMS and ROMs). The controller 99 implements various types of processing units by causing the CPU to execute predetermined programs stored in the storage 95. Note that these programs (to be specific, a group of program modules) may be recorded on a portable recording medium such as a USB memory (in other words, various types of non-transitory computer-readable recording media), read out from the recording medium, and installed in the authentication server 90. Alternatively, the programs may be downloaded via, for example, the network 108 and installed in the authentication server 90.

Specifically, as illustrated in FIG. 3, the controller 99 implements various types of processing units including a communication control unit 81, a determination unit 82, and an authentication processing unit 83 by executing, for example, the programs.

The communication control unit 81 is a processing unit that controls operations of communication with other devices (e.g., MFP 10) in cooperation with the communication unit 94. For example, the communication control unit 81 receives and acquires biological information on a to-be-authenticated user as input information (check source information) for one-to-many authentication from the MFP 10. The communication control unit 81 also transmits an authentication result of biometric authentication performed by the authentication processing unit 83 (result of determination as to whether the authentication has succeeded or failed) to the MFP 10.

The determination unit 82 is a processing unit that determines check target information for one-to-many authentication (information targeted for processing for checking against the input information for one-to-many authentication; at least one piece of biological information to be checked against the input information).

The authentication processing unit 83 is a processing unit that performs biometric authentication processing (biometric authentication processing through one-to-many authentication) that involves check processing for checking the input information against the check target information. Specifically, the authentication processing unit 83 performs biometric authentication through one-to-many authentication by checking the biological information on the to-be-authenticated user, read as the input information, against at least one piece of biological information determined as the check target information among a plurality of pieces of biological information.

Here, although description is given using an example of a mode in which the aforementioned various types of operations are primarily performed by the CPU of the controller 99 executing software programs, the present invention is not limited to this example, and the aforementioned various types of operations may be performed using, for example, dedicated hardware provided in the authentication server 90 (to be specific, inside or outside the controller 99). For example, all or some of the units such as the communication control unit 81, the determination unit 82, and the authentication processing unit 83 (FIG. 3) may be implemented by a single piece or a plurality of pieces of dedicated hardware.

### 1-4. Operations

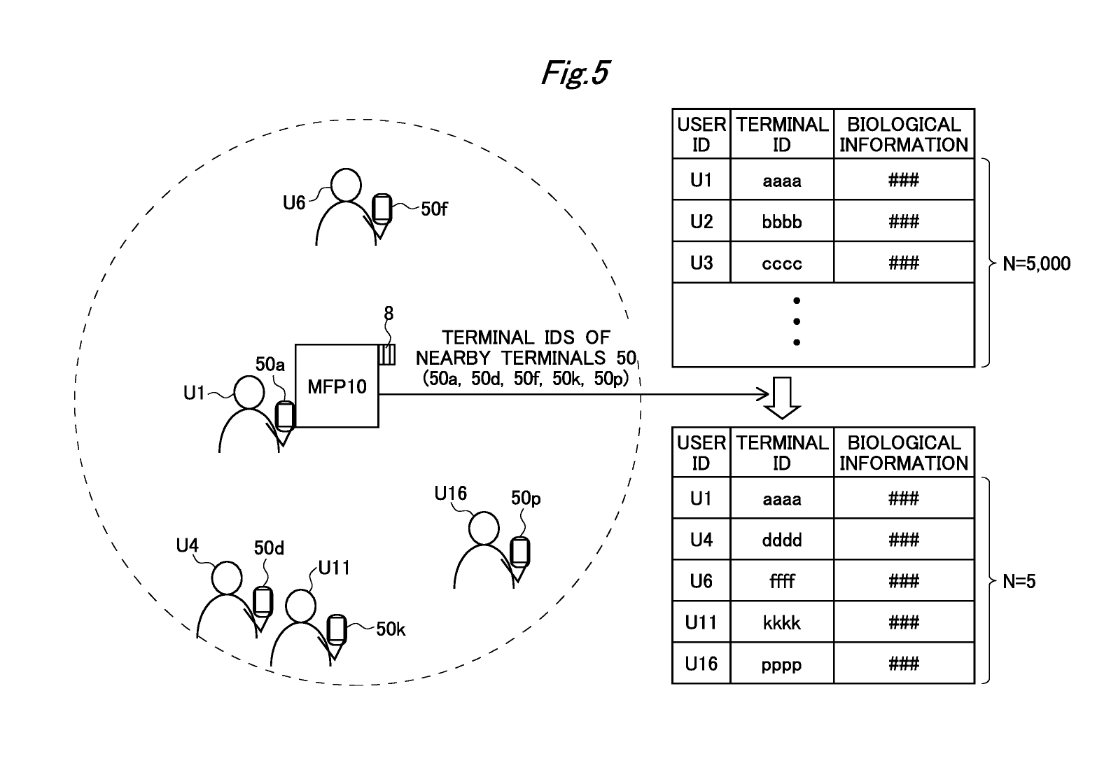

FIG. 5 illustrates general operations of the authentication system 1.

In the case where a to-be-authenticated user uses the MFP 10, the authentication system 1 performs biometric authentication through one-to-many authentication by narrowing down the check target information for one-to-many authentication to biological information (at least one piece of biological information) on users present in close proximity to the MFP 10 (to be specific, the biological information reader 8 of the MFP 10).

Specifically, when the biological information reader 8 of the MFP 10 has read biological information (here, fingerprint information) on the to-be-authenticated user, the MFP 10 performs detection processing for detecting nearby terminals (mobile terminals 50 present in closer proximity to the biological information reader 8). Thereafter, the authentication server 90 determines at least one piece of biological information registered in association with the user(s) of at least one mobile terminal 50 each detected as a nearby terminal among a plurality of pieces of biological information registered in advance as candidates for check target information for one-to-many authentication, as the check target information for one-to-many authentication. Then, the authentication server 90 performs biometric authentication (biometric authentication through one-to-many authentication) by checking the biological information on the to-be-authenticated user read as the input information for one-to-many authentication against the biological information determined as the check target information.

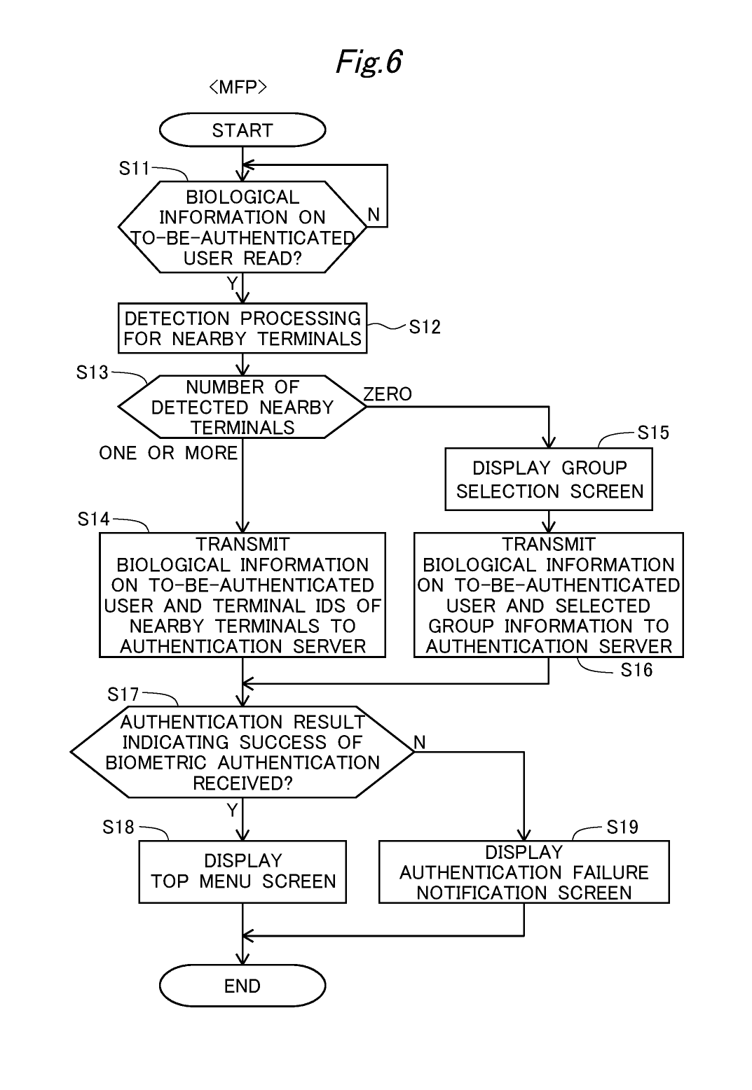

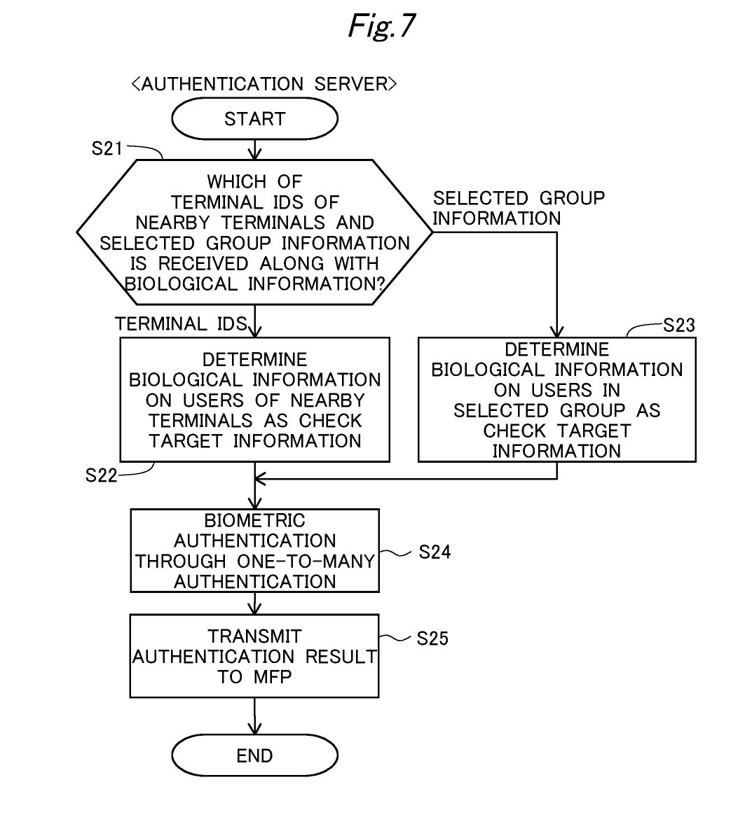

FIG. 6 is a flowchart of operations of the MFP 10. FIG. 7 is a flowchart of operations of the authentication server 90. The operations performed in the authentication system 1 will be described hereinafter with reference to, for example, FIGS. 6 and 7.

Here, a situation is assumed in which the user U1 who wishes to use the MFP 10 comes close to the MFP 10 and then places his or her finger on the biological information reader 8 of the MFP 10 (see FIG. 5).

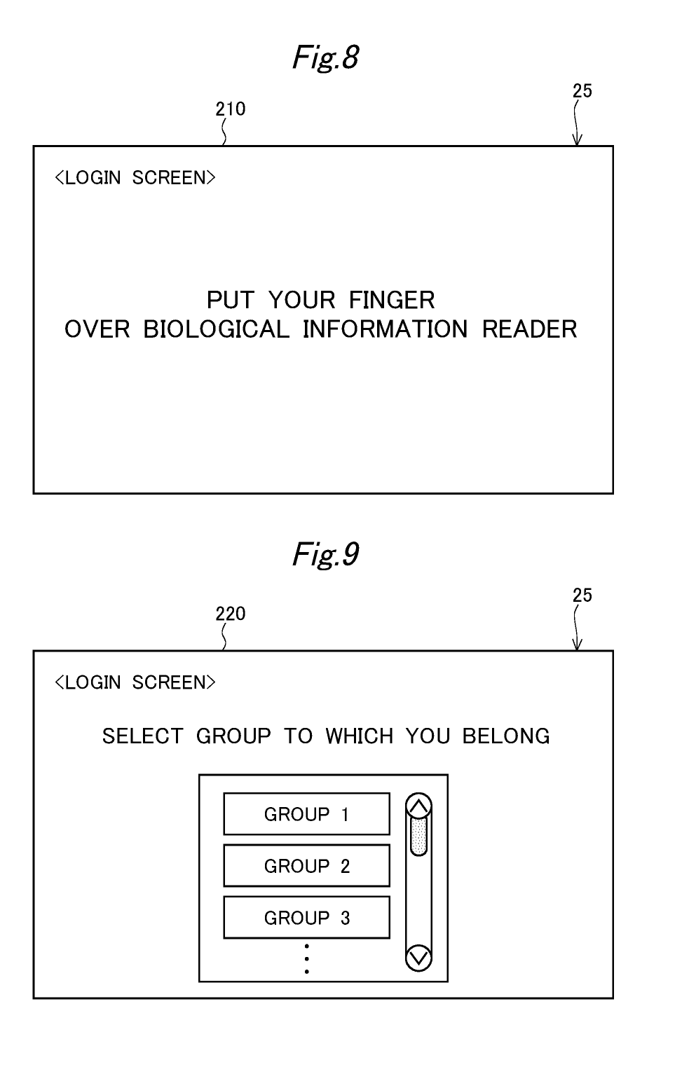

Specifically, the to-be-authenticated user (here, user U1) moves close to the MFP 10 (in the front of the MFP 10) before the start of the flowchart in FIG. 6. When the to-be-authenticated user stands in front of the MFP 10, the MFP 10 detects the presence of a person standing in front of the MFP 10 with, for example, a human detecting sensor (not shown) and displays a finger placement request screen 210 (FIG. 8) on the touch panel 25. The finger placement request screen 210 is a screen that prompts the to-be-authenticated user to place his or her finger on the biological information reader 8.

Then, when the to-be-authenticated user has placed (held) his or her finger on the biological information reader 8 of the MFP 10 (FIG. 1), the MFP 10 (biological information reader 8) reads and acquires fingerprint information on the finger of the to-be-authenticated user as input information for biometric authentication (here, biometric authentication through one-to-many authentication).

In step S11, the MFP 10 stands by until the biological information (fingerprint information) on the to-be-authenticated user is read by the biological information reader 8. When the fingerprint information on the finger of the to-be-authenticated user has been read by the biological information reader 8, the procedure advances from step S11 to step S12.

In step S12, in response to the fingerprint information on the to-be-authenticated user (U1) being read, the MFP 10 performs detection processing for detecting nearby terminals (mobile terminals 50 present in close proximity to the biological information reader 8 of the MFP 10).

Specifically, the MFP 10 (BLE communication unit 4b) detects mobile terminals 50 that are present within a predetermined range of distance from the biological information reader 8 as nearby terminals on the basis of the intensity of radio waves transmitted from mobile terminals 50 (radio waves for BLE communication between the BLE communication unit 4b and each mobile terminal 50). For example, if the intensity of radio waves received from one mobile terminal 50 is determined to be greater than a predetermined threshold value TH, the MFP 10 detects this one mobile terminal 50 as a nearby terminal. The MFP 10 also acquires terminal identification information (terminal IDs) from the mobile terminals 50 detected as nearby terminals.

Then, the procedure advances from step S12 to step S13, and the MFP 10 determines the number of detected nearby terminals and performs operations in accordance with the number of detected nearby terminals (steps S14 to S16).

For example, if at least one mobile terminal 50 has been detected as a nearby terminal, the procedure advances from step S13 to step S14, and the MFP 10 transmits the biological information on the to-be-authenticated user and the terminal ID(s) of the at least one mobile terminal 50 (nearby terminal) to the authentication server 90. In the present example, five mobile terminals 50 (50a, 50d, 50f, 50k, and 50p) are detected as nearby terminals, and the MFP 10 acquires the terminal IDs of the five mobile terminals 50 from each mobile terminal 50 and transmits these terminals IDs together with the biological information on the to-be-authenticated user to the authentication server 90 (see FIG. 5). Then, the MFP 10 stands by until the authentication result of biometric authentication performed by the authentication server 90 is received (step S17). Note that operations (steps S15 and S16) to be performed in the case where no nearby terminals have been detected will be described later.

When the biological information on the to-be-authenticated user (biological information read by the biological information reader 8) is received (acquired) as the input information for one-to-many authentication from the MFP 10, the authentication server 90 starts the flowchart in FIG. 7.

In step S21, the authentication server 90 determines which of the terminal IDs (terminals ID of nearby terminals) and selected group information (described later) has been received together with the biological information on the to-be-authenticated user. Here, the terminal IDs of the five mobile terminals 50 (nearby terminals) have been received together with the biological information on the to-be-authenticated user from the MFP 10, and therefore the procedure advances from step S21 to step S22. Note that operations to be performed in the case where the selected group information has been received together with the biological information on the to-be-authenticated user will be described later.

In step S22, the authentication server 90 determines at least one piece of biological information that is registered in association with the user(s) of at least one mobile terminal 50 each detected as a nearby terminal among a plurality of pieces of biological information registered in the biological information management table 300 (FIG. 4), as the check target information for one-to-many authentication.

Specifically, the authentication server 90 identifies the user(s) of at least one mobile terminal 50 each detected as a nearby terminal among a plurality of registered users, on the basis of the terminal IDs (terminal IDs of nearby terminals) received from the MFP 10. Then, the authentication server 90 determines at least one piece of biological information registered in association with the user(s) of the at least one mobile terminal 50 among a plurality of pieces of biological information registered in the biological information management table 300 (FIG. 4), as the check target information for one-to-many authentication. Here, users U1, U4, U6, U11, and U16 having each mobile terminal 50 are identified on the basis of the terminal IDs of the five mobile terminals 50 (50a, 50d, 50f, 50k, and 50p) detected as nearby terminals. Then, among a plurality of pieces of biological information registered in the biological information management table 300, the biological information (five pieces of biological information) on the five users (users U1, U4, U6, U11, and U16) (i.e., biological information on some users) is determined as the check target information (see also FIG. 5).

In this way, in the case where nearby terminals have detected when the MFP 10 is used by the to-be-authenticated user, biological information on the users of the mobile terminals 50 detected as the nearby terminals is determined as the check target information for one-to-many authentication.

Then, the procedure advances from step S22 to step S24.

In step S24, the authentication server 90 performs biometric authentication (here, fingerprint authentication) through one-to-many authentication.

Specifically, the authentication server 90 performs check processing for checking the biological information acquired as the input information (biological information on the to-be-authenticated user) against at least one piece of biological information (here, five pieces of biological information) determined as the check target information. Note that even in the case where a single mobile terminal 50 (e.g., only the mobile terminal 50a) has been detected as a nearby terminal and a single piece of biological information (here, authorized biological information on the user U1) has been determined as the check target information, check processing for checking the biological information on the to-be-authenticated user against this single piece of biological information is performed in one-to-many authentication.

When the biometric authentication has been performed, the procedure advances from step S24 to step S25, and the authentication server 90 transmits an authentication result of the biometric authentication (result of determination as to whether the authentication has succeeded or failed) to the MFP 10.

Then, the MFP 10 performs operations according to the authentication result of the biometric authentication (steps S17 to S19 in FIG. 6).

Specifically, in step S17, the MFP 10 determines whether the authentication result indicating that the biometric authentication has succeeded has been received from the authentication server 90.

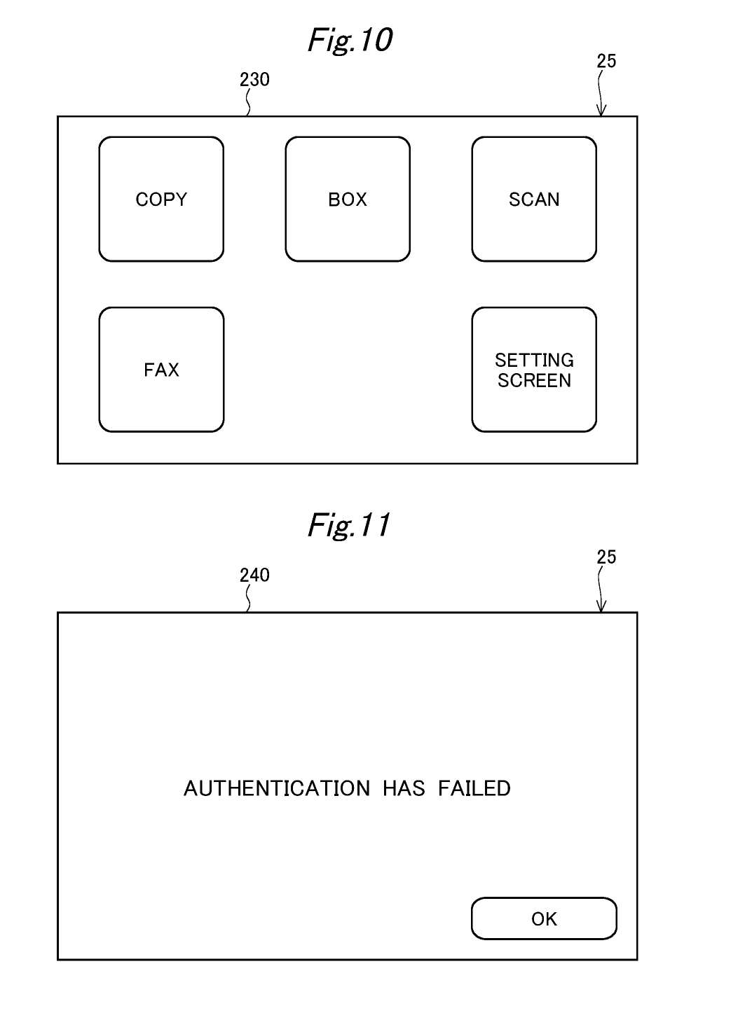

For example, if the authentication result indicating that the biometric authentication has succeeded has been received from the authentication server 90, the procedure proceeds to step S18, and the MFP 10 enables the to-be-authenticated user (here, user U1) to log in to the MFP 10 and displays a post-login display screen (here, a top menu screen 230 in FIG. 10) on the touch panel 25. Then, the to-be-authenticated user (login user) starts using the MFP 10.

On the other hand, if the authentication result indicating that the biometric authentication has failed has been received from the authentication server 90, the procedure advances from step S17 to step S19, and the MFP 10 does not enable the to-be-authenticated user (here, user U1) to log in to the MFP 10 and displays an authentication failure notification screen 240 (FIG. 11) for notifying the user that the login authentication (biometric authentication) has failed, on the touch panel 25.

In this way, according to the first embodiment, biological information on the user(s) of at least one mobile terminal 50 each detected as a nearby terminal among a plurality of pieces of biological information is determined as the check target information for one-to-many authentication (step S22 in FIG. 7). In other words, in the case where nearby terminals have been detected, the check target information is narrowed down not to biological information on users in one group selected by the to-be-authenticated user, but to biological information on users who are present in close proximity to the biological information reader 8 (users of nearby terminals). Thus, in the case where nearby terminals have been detected, there is no need for the to-be-authenticated user to select the group to which he or she belongs, in order to narrow down the check target information. Accordingly, it is possible to reduce time and effort to select the group to which the to-be-authenticated user belongs during biometric authentication (biometric authentication through one-to-many authentication).

Now, refer back to the description of step S13 in FIG. 6.

There are also cases where the to-be-authenticated user (here, user U1) does not carry his or her own mobile terminal 50 when using the MFP 10, and accordingly no nearby terminals have been detected in the detection processing for detecting nearby terminals in step S12. In such a case (where the number of detected nearby terminals is zero), as will be described later, the to-be-authenticated user is enabled to select the group to which he or she belongs, and then biological information on users who belong to the group to which the to-be-authenticated user belongs is determined as the check target information for one-to-many authentication in the same manner as in the aforementioned conventionally technique.

Specifically, in the case where the to-be-authenticated user (user U1) does not carry his or her mobile terminal 50 and no nearby terminals have been detected in step S12, the procedure advances from step S13 to step S15.

In step S15, the MFP 10 displays a group selection screen 220 (see FIG. 9) that receives an operation of selecting the group to which the to-be-authenticated user belongs from among a plurality of groups, on the touch panel 25. The to-be-authenticated user (here, user U1) selects the group to which he or she belongs (e.g., “group 1”) on the group selection screen 220.

Then, when the group to which the to-be-authenticated user belongs has been selected, the MFP 10 transmits the biological information on the to-be-authenticated user (input information for one-to-many authentication) and selected group information (here, “group 1”) that indicates the group number of one group (selected group) selected in accordance with the operation made through the group selection screen 220, to the authentication server 90 (step S16).

When the selected group information has been received together with the biological information on the to-be-authenticated user, the authentication server 90 advances the procedure from step S21 (FIG. 7) to step S23.

In step S23, the authentication server 90 determines biological information on all users (here, 500 users) who belong to the selected group (here, “group 1”) among a plurality of pieces of biological information registered in the biological information management table 300 (FIG. 4), as the check target information for one-to-many authentication. Then, the procedure advances from step S23 to step S24.

In step S24, the authentication server 90 performs biometric authentication (here, fingerprint authentication) through one-to-many authentication. Specifically, the authentication server 90 performs check processing for checking the biological information acquired as the input information (biological information read from the to-be-authenticated user) against the biological information determined as the check target information (here, biological information on all users who belong to the “group 1”).

Then, the authentication server 90 transmits the authentication result of the biometric authentication to the MFP 10 (step S25), and the MFP 10 displays either the top menu screen 230 (FIG. 10) or the authentication failure notification screen 240 (FIG. 11) on the touch panel 25 in accordance with the authentication result of the biometric authentication (steps S17 to S19).

In this way, in the case where no nearby terminals have been detected, the group selection screen 220 (FIG. 9) is displayed (step S15 in FIG. 6), and biological information on users who belong to one group selected on the group selection screen 220 is determined as the check target information for one-to-many authentication (step S23 in FIG. 7). Thus, even if the to-be-authenticated user does not carry his or her mobile terminal 50 and accordingly no nearby terminals have been detected, it is possible to perform processing for authenticating the to-be-authenticated user.

### 1-5. First Modified Example of First Embodiment

In the above-described first embodiment, whether the to-be-authenticated user carry a mobile terminal 50 may be confirmed.

Here, a case is also conceivable in which although the to-be-authenticated user does not carry (have) his or her own mobile terminal 50 when using the MFP 10, nearby terminals may be detected due to the presence of other users (users having mobile terminals 50) in close proximity to the MFP 10. In this case, biological information on users carrying the nearby terminals (users other than the to-be-authenticated user) is determined as the check target information, and authorized biological information on the to-be-authenticated user is not included in this check target information. As a result, the biometric authentication of the to-be-authenticated user will fail because the authorized biological information on the to-be-authenticated user is not included in the check target information.

In order to avoid such a situation (in order to more reliably include the authorized biological information on the to-be-authenticated user in the check target information), whether the to-be-authenticated user carries a mobile terminal 50 is confirmed in this modified example.

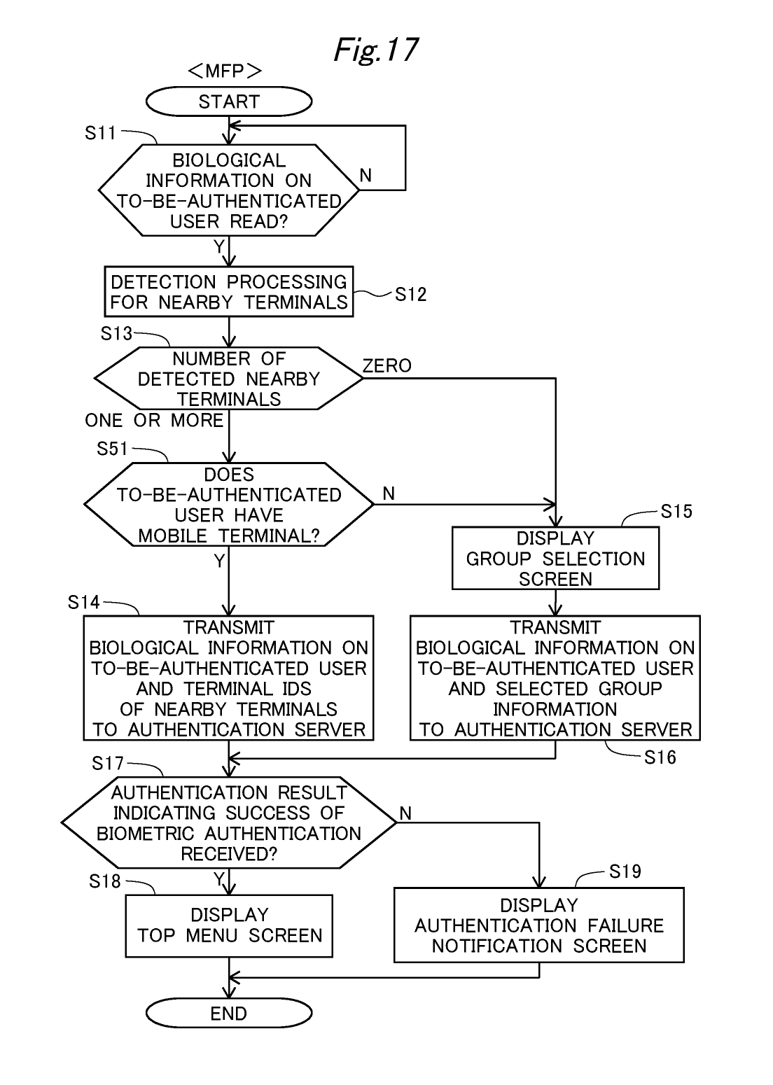

FIG. 17 is a flowchart of operations of the MFP 10 according to this modified example. In this modified example, step S51 is added between steps S13 and S14 in FIG. 6.

First, when the presence of a person standing in front of the MFP 10 has been detected with, for example, a human detecting sensor (not shown) prior to step S11, the MFP 10 confirms whether the to-be-authenticated user carries (has) a mobile terminal 50 (mobile terminal 50 that emits radio waves for BLE communication) by making inquiry at the to-be-authenticated user.

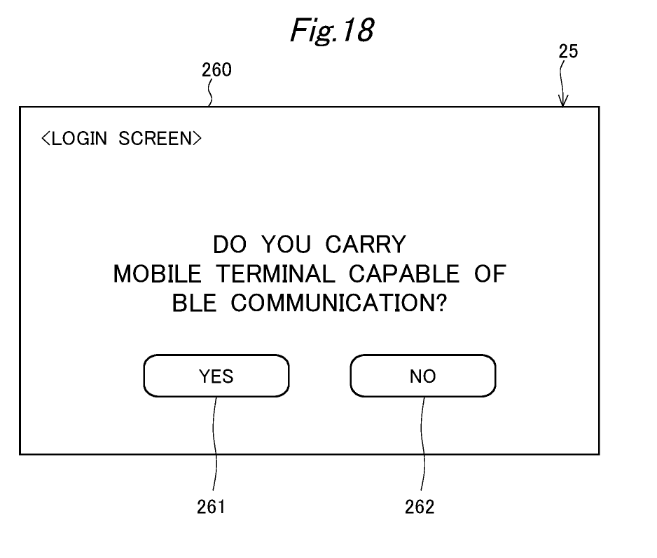

Specifically, the MFP 10 displays a terminal-carrying confirmation screen 260 (see FIG. 18) for making an inquiry as to whether the to-be-authenticated user carries a terminal 50 at the to-be-authenticated user, on the touch panel 25. If the to-be-authenticated user carries a mobile terminal 50, the to-be-authenticated user presses an “YES” button 261. On the other hand, if the to-be-authenticated user does not carry a mobile terminal 50, the to-be-authenticated user presses a “NO” button 262.

After whether the to-be-authenticated user carries a mobile terminal 50 has been confirmed through the terminal-carrying confirmation screen 260, the MFP 10 displays the finger placement request screen 210 (FIG. 8) on the touch panel 25. Then, the to-be-authenticated user places his or her finger on the biological information reader 8 (FIG. 1) of the MFP 10, and the biological information reader 8 reads fingerprint information on the finger of the to-be-authenticated user.

When the biological information on the to-be-authenticated user has been read by the biological information reader 8, the procedure advances from step S11 to step S12, and the MFP 10 performs detection processing for detecting nearby terminals.

Then, if nearby terminals have been detected, the procedure advances from step S12 via step S13 to step S51, and the MFP 10 determines whether the to-be-authenticated user has been confirmed to carry (have) a mobile terminal 50.

For example, if the “YES” button 261 has been pressed on the terminal-carrying confirmation screen 260 (FIG. 18), the MFP 10 determines in step S51 that the to-be-authenticated user has been confirmed to carry (have) a mobile terminal 50. When the to-be-authenticated user has been confirmed to carry a mobile terminal 50 by making inquiry at the to-be-authenticated user, the procedure advances from step S51 to step S14, and the MFP 10 transmits the biological information on the to-be-authenticated user and the terminal IDs of the nearby terminals to the authentication server 90.

Then, the authentication server 90 determines at least one piece of biological information registered in association with the user(s) of at least one mobile terminal 50 (including the mobile terminal 50 of the to-be-authenticated user) detected as the nearby terminals among the plurality of pieces of biological information, as the check target information for one-to-many authentication (step S22 in FIG. 7).

On the other hand, if the “NO” button 262 has been pressed on the terminal-carrying confirmation screen 260 (FIG. 18), the MFP 10 determines in step S51 that the to-be-authenticated user has been confirmed not to carry (have) a mobile terminal 50. When the to-be-authenticated user has been confirmed not to carry a mobile terminal 50 by making inquiry at the to-be-authenticated user, the procedure advances from step S51 to step S15, and the MFP 10 displays the group selection screen 220 (FIG. 9) on the touch panel 25.

Then, the authentication server 90 determines biological information on all users who belong to the selected group (one group selected in accordance with the operation made through the group selection screen 220) among a plurality of pieces of biological information, as the check target information for one-to-many authentication (step S23). In other words, in the case where the to-be-authenticated user has been confirmed not to carry a mobile terminal 50, not the biological information on users carrying nearby terminals, but the biological information on users in the selected group is determined as the check target information, even if nearby terminals have been detected.

In this way, in the first embodiment, whether the to-be-authenticated user carries a mobile terminal 50 may be confirmed to the to-be-authenticated user.

In this case, whether the to-be-authenticated user carries (has) a mobile terminal 50 is confirmed to the to-be-authenticated user, and then at least one piece of biological information registered in association with the user(s) of at least one mobile terminal 50 each detected as a nearby terminal is determined as the check target information. In other words, at least one piece of biological information registered in association with the user(s) of at least one mobile terminal 50 each detected as a nearby terminal is determined as the check target information, on condition that the mobile terminal 50 of the to-be-authenticated user is included in the at least one mobile terminal 50. Accordingly, it is possible to more reliably include authorized biological information on the to-be-authenticated user in the check target information for one-to-many authentication.

Here, the terminal-carrying confirmation screen 260 (FIG. 18) is displayed in response to a person standing in front of the MFP 10 being detected prior to step S11, but the present invention is not limited to this example. For example, when nearby terminals have been detected, the terminal-carrying confirmation screen 260 may be displayed between step S13 and step S51 in order to confirm whether the mobile terminal 50 of the to-be-authenticated user is included in the mobile terminals 50 detected as nearby terminals.

### 1-6. Second Modified Example of First Embodiment

According to the above-described first embodiment, in the case where no nearby terminals have been detected, the group selection screen 220 (FIG. 9) is displayed (step S15 in FIG. 6), and biological information on users who belong to one group selected on the group selection screen 220 is determined as the check target information for one-to-many authentication (step S23 in FIG. 7). However, the present invention is not limited to this example. For example, in the case where no nearby terminals have been detected, biological information on all registered users (here, 5000 users) may be determined as the check target information for one-to-many authentication, without enabling the to-be-authenticated user to perform the operation of selecting the group to which he or she belongs.

### 2. Second Embodiment

A second embodiment is a variation of the first embodiment. The following description focuses on differences from the first embodiment.

In the first embodiment, the authentication system 1 performs biometric authentication through one-to-many authentication.

In contrast, according to the second embodiment, the authentication system 1 performs biometric authentication (here, fingerprint authentication) through one-to-one authentication.

The one-to-one authentication as used herein refers to an authentication technique for receiving a designation operation of designating one user who corresponds to check target information (information targeted for processing for checking against input information), and then performing check processing for checking input information (biological information on a to-be-authenticated user) against the check target information (one piece of biological information that corresponds to one user designated by the designation operation among a plurality of pieces of biological information registered in advance).

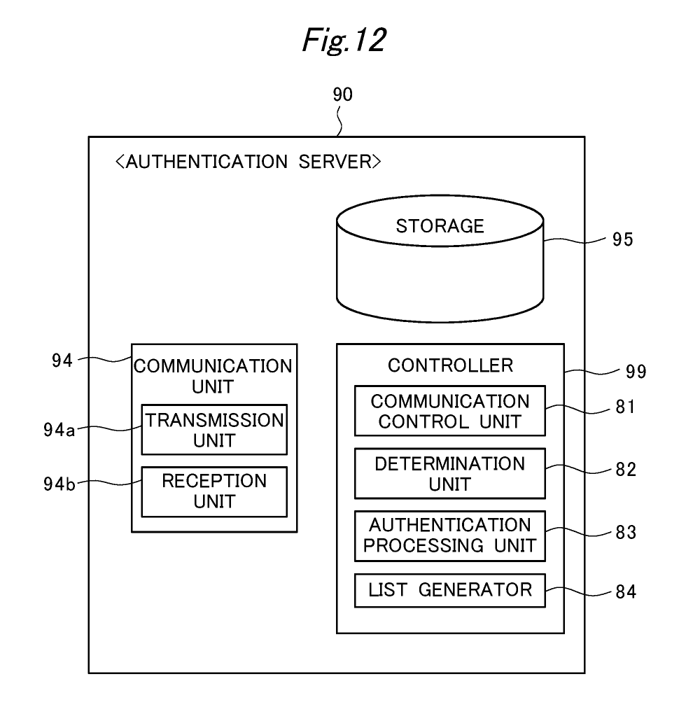

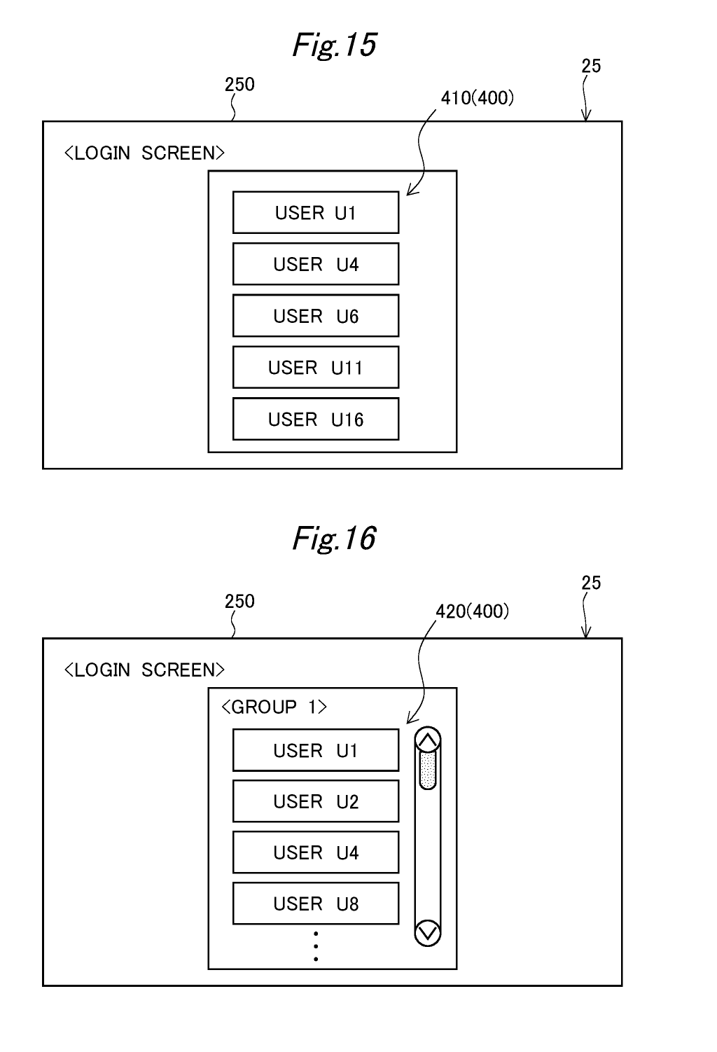

FIG. 12 is a functional block diagram illustrating a schematic configuration of the authentication server 90 according to the second embodiment. The authentication server 90 according to the second embodiment further includes a list generator 84. The list generator 84 is a processing unit that performs list generation processing for generating a user designation list 400 (see, for example, FIG. 15). The user designation list 400 is a user list for designating one user who corresponds to check target information (one piece of biological information) for one-to-one authentication. Some of a plurality of registered users (here, 5000 users) are listed in the user designation list 400.

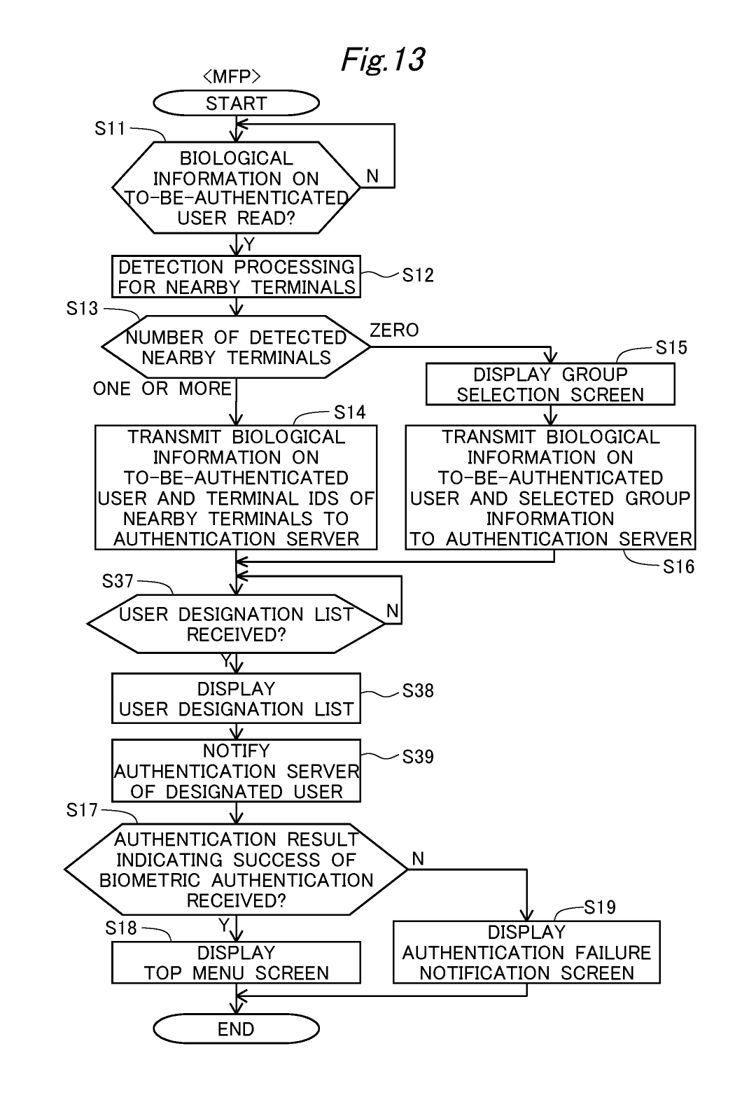

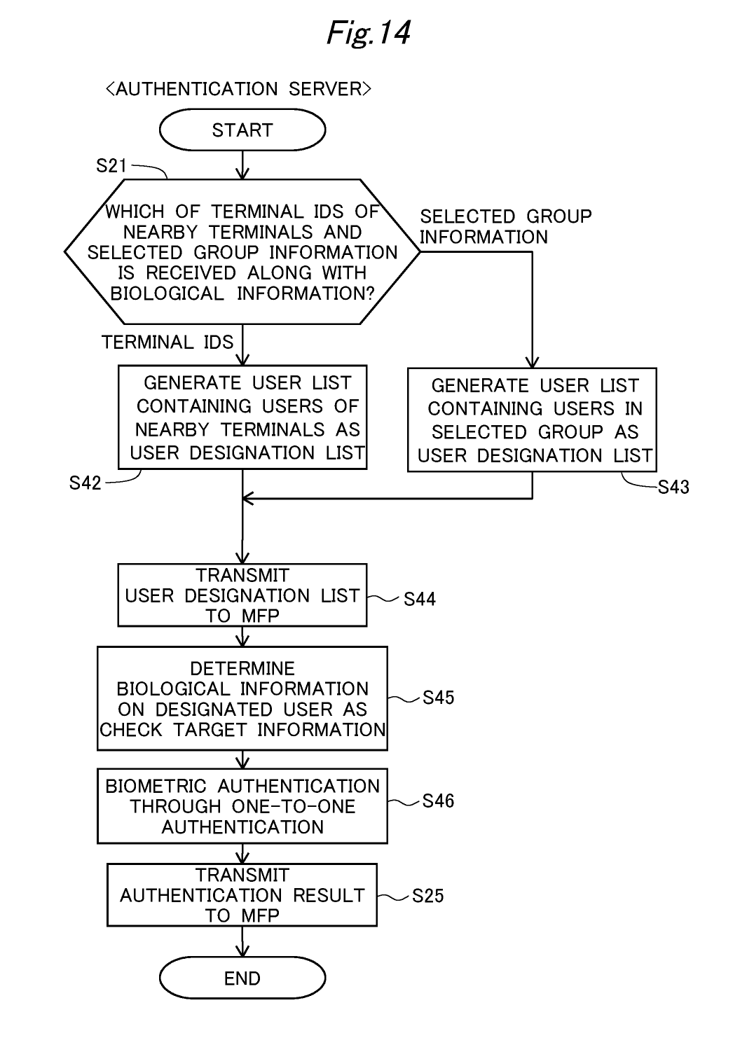

Operations of the authentication system 1 according to the second embodiment will be described hereinafter with reference to, for example, FIGS. 13 and 14.

FIG. 13 is a flowchart of operations of the MFP 10 according to the second embodiment. In this second embodiment, processing of steps S37 to S39 is added between step S14 (S16) and step S17 in FIG. 6. Note that the content of the processing of steps S11 to S19 in FIG. 13 is the same as the content of processing of steps S11 to S19 in FIG. 6 according to the first embodiment. FIG. 14 is a flowchart of operations of the authentication server 90 according to the second embodiment.

Here, as in the first embodiment, a situation is assumed in which the user U1 who wishes to use the MFP 10 comes close to the MFP 10 and then places his or her finger on the biological information reader 8 of the MFP 10.

When biological information (fingerprint information) on a to-be-authenticated user (here, user U1) has been read (step S11 in FIG. 13), detection processing for detecting nearby terminals is performed (step S12), and then the number of detected nearby terminals is determined (step S13). For example, in the case where at least one mobile terminal 50 has been detected as a nearby terminal, the MFP 10 transmits the biological information on the to-be-authenticated user and the terminal ID(s) of the at least one mobile terminal 50 each detected as a nearby terminal to the authentication server 90 (step S14). Note that operations to be performed in the case where no nearby terminals have been detected (steps S15 and S16) will be described later.

When information has been received from the MFP 10 (step S14 or S16), the authentication server 90 generates the user designation list 400 that varies depending on whether the information received along with the biological information on the to-be-authenticated user is the terminal ID(s) of the nearby terminal(s) or selected group information (steps S42 and S43 in FIG. 14).

For example, in the case where the terminal ID(s) has/have been received together with the biological information on the to-be-authenticated user (step S21), the authentication server 90 generates a user list 410 (see FIG. 15) consisting of the user(s) of the at least one mobile terminal 50, each detected as a nearby terminal, among a plurality of users registered in the authentication system 1, as the user designation list 400 (step S42).

Specifically, the authentication server 90 identifies the user(s) of the at least one mobile terminal 50, each detected as a nearby terminal in the detection processing (step S12) performed by the MFP 10, among a plurality of registered users on the basis of the terminal ID(s) (terminal ID(s) of the nearby terminal(s)) received from the MFP 10. Then, the authentication server 90 generates the user list 410 consisting of the identified users as the user designation list 400. For example, in the case where five mobile terminals 50 (50a, 50d, 50f, 50k, and 50p) have been detected as nearby terminals, the user list 410 (FIG. 15) that contains the users (users U1, U4, U6, U11, and U16; some users) of the respective mobile terminals 50 among a plurality of registered users is generated as the user designation list 400 on the basis of the terminal IDs of the respective mobile terminals 50.

In this way, in the case where nearby terminals have been detected when the to-be-authenticated user uses the MFP 10, a user list consisting of users carrying mobile terminals 50 detected as nearby terminals is generated as the user designation list 400.

Then, the procedure advances from step S42 to step S44, and the authentication server 90 transmits and displays the generated user designation list 400 (here, the user list 410 consisting of the users U1, U4, U6, U11, and U16) to and on the MFP 10 (step S44).

When the user designation list 400 has been received from the authentication server 90 (step S37), the MFP 10 displays this user designation list 400 on the touch panel 25 (step S38). Here, the MFP 10 displays the user list 410 (FIG. 15) that contains users (users U1, U4, U6, U11, and U16) carrying the five mobile terminals 50 detected as nearby terminals as the user designation list 400 on the touch panel 25. Note that FIG. 15 illustrates a list display screen 250 that displays the user designation list 400.

Thereafter, the to-be-authenticated user designates one user who corresponds to the check target information for one-to-one authentication from the user designation list 400 (here, user list 410). For example, the to-be-authenticated user (user U1) designates the user U1 himself or herself (“user U1”) from the user list 410.

In response to the operation (designation operation) made through the user designation list 400 (user list 410), the MFP 10 notifies the authentication server 90 of one user (designated user) designated by the to-be-authenticated user (step S39).

The authentication server 90 determines (identifies) one piece of biological information that is registered in association with the designated user notified by the MFP 10 among a plurality of pieces of biological information registered in the biological information management table 300 (FIG. 4), as the check target information for one-to-one authentication (step S45).

Then, the authentication server 90 performs biometric authentication (fingerprint authentication) through one-to-one authentication (step S46). Specifically, the authentication server 90 performs check processing for checking the biological information read as the input information (biological information on the to-be-authenticated user) against the one piece of biological information determined as the check target information (biological information on the designated user).

After execution of the biometric authentication, the procedure advances from step S46 to step S25, and the authentication server 90 transmits an authentication result of the biometric authentication to the MFP 10.

Then, the MFP 10 displays either the top menu screen 230 (FIG. 10) or the authentication failure notification screen 240 (FIG. 11) on the touch panel 25 in accordance with the authentication result of the biometric authentication (biometric authentication through one-to-one authentication) (steps S17 to S19).

In this way, according to the second embodiment, a user list consisting of the user(s) of at least one mobile terminal 50 each detected as a nearby terminal among a plurality of registered users is generated as the user designation list 400 (user list for designating one user who corresponds to the check target information for one-to-one authentication) (step S42 in FIG. 14). In other words, in the case where nearby terminals have been detected, the users listed up in the user designation list 400 are narrowed down, not to users in one group selected by the to-be-authenticated user, but to users present in close proximity to the biological information reader 8 (users carrying nearby terminals). Thus, in the case where nearby terminals have been detected, there is no need for the to-be-authenticated user to select the group to which he or she belongs, in order to narrow down the users who are to be listed up in the user designation list 400. Accordingly, it is possible to reduce time and effort to select the group to which the to-be-authenticated user belongs during biometric authentication (biometric authentication through one-to-one authentication).

Now, refer back to the description of step S13 in FIG. 13.

There are also cases where the to-be-authenticated user (here, user U1) does not carry his or her own mobile terminal 50 when using the MFP 10, and accordingly no nearby terminals have been detected in the detection processing for detecting nearby terminals in step S12. In such a case (where the number of detected nearby terminals is zero), the procedure advances from step S13 to step S15, and the MFP 10 displays the group selection screen 220 (FIG. 9) on the touch panel 25. Then, when the group (e.g., “group 1”) to which the to-be-authenticated user belongs has been selected, the MFP 10 transmits the biological information on the to-be-authenticated user and the selected group information (here, “group 1”) to the authentication server 90 (step S16).

When the selected group information has been received along with the biological information on the to-be-authenticated user (step S21 in FIG. 14), the authentication server 90 advances the procedure from step S21 to step S43.

In step S43, the authentication server 90 generates, as the user designation list 400, a user list 420 (see FIG. 16) consisting of all users who belong to the selected group (one group selected in accordance with the operation made through the group selection screen 220; here, “group 1”) among the plurality of registered users. Here, the user list 420 that contains all users (here, 500 users) who belong to the “group 1” among a plurality of registered users is generated as the user designation list 400.

Then, the procedure advances from step S43 to step S44, and the authentication server 90 transmits the generated user designation list 400 (here, user list 420 consisting of the users in the “group 1”) to the MFP 10 for display.

When the user designation list 400 (here, user list 420) has been received from the authentication server 90 (step S37), the MFP 10 displays the user designation list 400(420) (see FIG. 16) on the touch panel 25 (step S38). Then, the to-be-authenticated user (here, user U1) designates one user (“user U1”) who corresponds to the check target information for one-to-one authentication from the user list 410 (step S39).

Thereafter, the authentication server 90 performs biometric authentication through one-to-one authentication by checking the biological information on the to-be-authenticated user against the biological information on the designated user (steps S45 and S46) and transmits the authentication result to the MFP 10 (step S25).

Then, the MFP 10 displays either the top menu screen 230 (FIG. 10) or the authentication failure notification screen 240 (FIG. 11) on the touch panel 25 in accordance with the authentication result of the biometric authentication (steps S17 to S19).

In this way, in the case where no nearby terminals have been detected, the group selection screen 220 (FIG. 9) is displayed (step S15 in FIG. 13), and a user list consisting of users who belong to one group selected on the group selection screen 220 is generated as the user designation list 400 (step S43 in FIG. 14). Accordingly, even if the to-be-authenticated user does not carry his or her own mobile terminal 50 and no nearby terminals have been detected, the to-be-authenticated user is able to designate one user (the to-be-authenticated user himself or herself) who corresponds to the check target information from the user designation list 400.

### 2-1. First Modified Example of Second Embodiment

In the above-described second embodiment, whether the to-be-authenticated user carries a mobile terminal 50 may be confirmed.

Here, a case is also conceivable in which although the to-be-authenticated user does not carry (have) his or her own mobile terminal 50 when using the MFP 10, nearby terminals may be detected due to the presence of other users (users carrying mobile terminals 50) in close proximity to the MFP 10. In this case, a user list consisting of the users of the nearby terminals (users other than the to-be-authenticated user) is generated as the user designation list 400, and the to-be-authenticated user is not included in the user designation list 400. As a result, the to-be-authenticated user is unable to designate one user (to-be-authenticated user himself or herself) who corresponds to the check target information for one-to-one authentication from the user designation list 400.

In order to avoid such a situation (in order to more reliably include the to-be-authenticated user in the user designation list 400), whether the to-be-authenticated user carries a mobile terminal 50 is confirmed in this modified example.

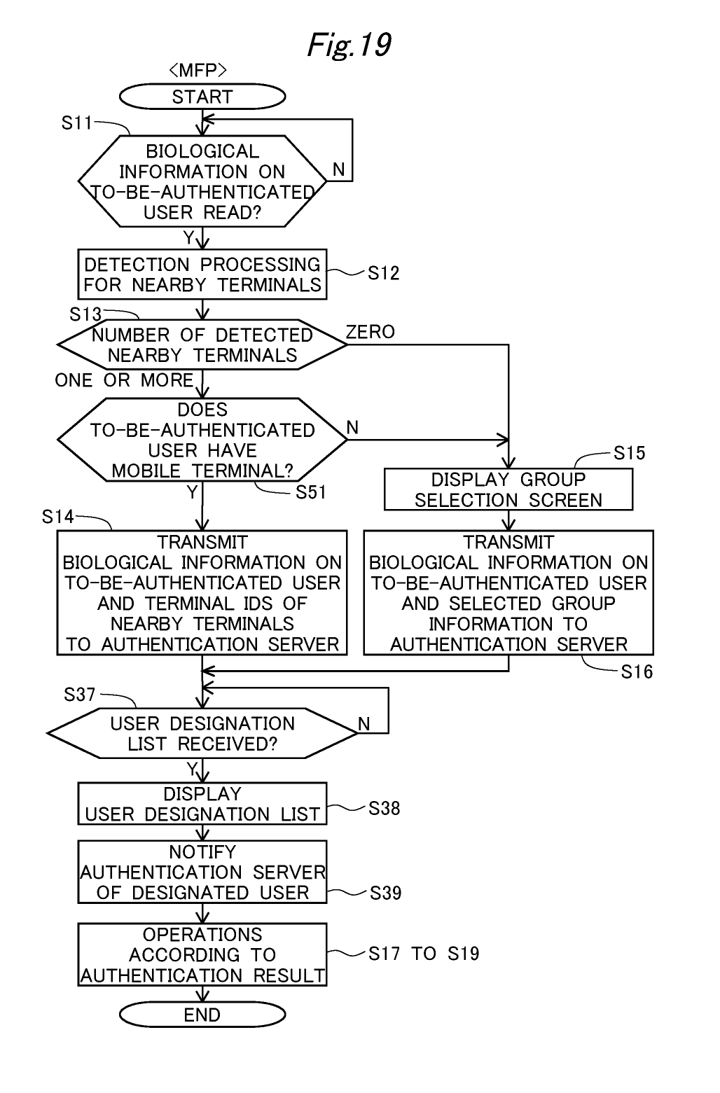

FIG. 19 is a flowchart of operations of the MFP 10 according to this modified example. In this modified example, step S51 is added between step S13 and step S14 in FIG. 13. Although the processing of steps S17 to S19 in FIG. 13 is described as “operations according to the authentication result” for the convenience of illustration, the content of processing performed in each of steps S17 to S19 is the same as that described in the second embodiment.

First, when the presence of a person standing in front of the MFP 10 has been detected with, for example, a human detecting sensor (not shown) prior to step S11, the MFP 10 displays the terminal-carrying confirmation screen 260 (FIG. 18) on the touch panel 25. Then, the MFP 10 confirms, through the terminal-carrying confirmation screen 260, whether the to-be-authenticated user carries (has) a mobile terminal 50 (mobile terminal 50 that emits radio waves for BLE communication) by making inquiry at the to-be-authenticated user.

After whether the to-be-authenticated user carries a mobile terminal 50 has been confirmed through the terminal-carrying confirmation screen 260, the MFP 10 displays the finger placement request screen 210 (FIG. 8) on the touch panel 25. Then, the to-be-authenticated user places his or her finger on the biological information reader 8 (FIG. 1) of the MFP 10, and the biological information reader 8 reads fingerprint information on the finger of the to-be-authenticated user.

When the biological information on the to-be-authenticated user has been read by the biological information reader 8, the procedure advances from step S11 to step S12, and the MFP 10 performs detection processing for detecting nearby terminals.

Then, if nearby terminals have been detected, the procedure advances from step S12 via step S13 to step S51, and the MFP 10 determines whether the to-be-authenticated user has been confirmed to carry (have) a mobile terminal 50.

For example, if the “YES” button 261 has been pressed on the terminal-carrying confirmation screen 260 (FIG. 18), the MFP 10 determines in step S51 that the to-be-authenticated user has been confirmed to carry (have) a mobile terminal 50. When the to-be-authenticated user has been confirmed to carry a mobile terminal 50 by making inquiry at the to-be-authenticated user, the procedure advances from step S51 to step S14, and the MFP 10 transmits the biological information on the to-be-authenticated user and the terminal IDs of the nearby terminals to the authentication server 90.

Then, the authentication server 90 generates, as the user designation list 400, a user list consisting of the user(s) of at least one mobile terminal 50 (including the mobile terminal 50 of the to-be-authenticated user) each detected as a nearby terminal among a plurality of registered users (step S42 in FIG. 14).

On the other hand, if the “NO” button 262 has been pressed on the terminal-carrying confirmation screen 260 (FIG. 18), the MFP 10 determines in step S51 that the to-be-authenticated user has been confirmed not to carry (have) a mobile terminal 50. When the to-be-authenticated user has been confirmed not to carry a mobile terminal 50 by making inquiry at the to-be-authenticated user, the procedure advances from step S51 to step S15, and the MFP 10 displays the group selection screen 220 (FIG. 9) on the touch panel 25.

Then, the authentication server 90 generates, as the user designation list 400, a user list consisting of all users who belong to the selected group (group to which the to-be-authenticated user belongs) among a plurality of registered users (step S43). In other words, in the case where the to-be-authenticated user has been confirmed not to carry a mobile terminal 50, even if nearby terminals have been detected, a user list consisting not of the users of the nearby terminals, but of the users in the selected group is generated as the user designation list 400.

In this way, in the second embodiment, whether the to-be-authenticated user carries a mobile terminal 50 may be confirmed to the to-be-authenticated user.

In this case, whether the to-be-authenticated user carries (has) a mobile terminal is confirmed to the to-be-authenticated user, and then a user list consisting of the user(s) of at least one mobile terminal 50 each detected as a nearby terminal is generated as the user designation list 400. Accordingly, it is possible to more reliably include the to-be-authenticated user in the user designation list 400.

Here, the terminal-carrying confirmation screen 260 (FIG. 18) is displayed in response to a person standing in front of the MFP 10 being detected prior to step S11, but the present invention is not limited to this example. For example, when nearby terminals have been detected, the terminal-carrying confirmation screen 260 may be displayed between step S13 and step S51 in order to confirm whether the mobile terminal 50 of the to-be-authenticated user is included in the mobile terminals 50 detected as nearby terminals.

### 2-2. Second Modified Example of Second Embodiment

According to the above-described second embodiment, in the case where no nearby terminals have been detected, the group selection screen 220 (FIG. 9) is displayed (step S15 in FIG. 13), and a user list consisting of users who belong to one group selected on the group selection screen 220 is generated as the user designation list 400 (step S43 in FIG. 14). However, the present invention is not limited to this example. For example, in the case where no nearby terminals have been detected, a user list consisting of all registered users (here, 5000 users) may be generated as the user designation list 400, without enabling the to-be-authenticated user to perform the operation of selecting the group to which he or she belongs.

### 3. Variations

While embodiments of the present invention have been described thus far, the present invention is not intended to be limited to the content described above.

### 3-1. Variation on Timing of Execution of Nearby-Terminal Detection Processing

For example, in each embodiment and variation described above, the detection processing for detecting nearby terminals (step S12) is performed after the biological information on the to-be-authenticated user has been read (after step S11 in FIG. 6, for example), but the present invention is not limited to this, and the detection processing for detecting nearby terminals may be performed at fixed time intervals. Then, a detection result obtained by the latest one of the detection processing performed at fixed time intervals may be used.

Specifically, the MFP 10 performs detection processing for detecting nearby terminals at fixed time intervals (e.g., at 10-second intervals). When biometric authentication (here, fingerprint information) on a to-be-authenticated user has been read as a result of the to-be-authenticated user placing his or her finger on the biological information reader 8, the procedure advances from step S11 (FIG. 6) to step S13, without performing step S12. Then, the MFP 10 determines the number of nearby terminals detected by the latest (last) one of the detection processing (processing for detecting nearby terminals) performed before the biological information on the to-be-authenticated user has been read (step S13). When nearby terminals have been detected by the latest detection processing, the procedure advances from step S13 to step S14, and the MFP 10 transmits the terminal IDs of the mobile terminals 50 detected as the nearby terminals in the latest detection processing and the biological information on the to-be-authenticated user to the authentication server 90.

Thereafter, for example in the first embodiment, the authentication server 90 determines biological information on the user(s) of at least one mobile terminal 50 each detected as a nearby terminal by the latest detection processing among a plurality of pieces of biological information, as the check target information for one-to-many authentication (step S22 in FIG. 7).

Also, in the second embodiment, the authentication server 90 generates, as the user designation list 400, a user list consisting of the user(s) of at least one mobile terminal 50 each detected as a nearby terminal by the latest detection processing among a plurality of registered users (step S42 in FIG. 14).

In this way, the detection processing for detecting nearby terminals may be performed at fixed time intervals.

### 3-2. Variation on Subject Executing Biometric Authentication

In each embodiment and variation described above, the authentication server 90 performs biometric authentication, but the present invention is not limited to this, and biometric authentication may be performed not by the authentication server 90, but by the MFP 10. In this case, the MFP 10 (to be specific, the controller 9 of the MFP 10) serves also as an authentication control device.

For example, in the first embodiment, the following operations are performed in the case where biometric authentication is performed not by the authentication server 90, but by the MFP 10.

Specifically, the biological information management table 300 (FIG. 4) is stored in the MFP 10, and the determination unit 82 and the authentication processing unit 83 (FIG. 3) of the authentication server 90 according to the first embodiment are provided in the MFP 10. Then, the MFP 10 performs processing for determining check target information for one-to-many authentication (see steps S22 and S23 in FIG. 7) and biometric authentication through one-to-many authentication processing (see step S24 in FIG. 7).

More specifically, in the case where nearby terminals have been detected by the detection processing for detecting nearby terminals (step S12), the MFP 10 performs the same processing as that of step S22 (FIG. 7), instead of the processing of step S14 (FIG. 6). To be specific, the MFP 10 identifies the user(s) of at least one mobile terminal 50 each detected as a nearby terminal on the basis of the terminal ID(s) of the at least one mobile terminal 50. Then, the MFP 10 determines at least one piece of biological information registered in association with the user(s) of the at least one mobile terminal 50 among a plurality of pieces of biological information registered in the biological information management table 300, as the check target information for one-to-many authentication. On the other hand, in the case where no nearby terminals have been detected by the detection processing for detecting nearby terminals (step S12), the MFP 10 performs the same processing as that of step S23 (FIG. 7). To be specific, the MFP 10 determines biological information on all users who belong to one group (selected group) selected in accordance with the operation made through the group selection screen 220 (FIG. 9) among the plurality of pieces of biological information, as the check target information for one-to-many authentication.

Then, the MFP 10 performs the same processing as that of step S24 (FIG. 7). Specifically, the MFP 10 performs biometric authentication through one-to-many authentication by checking the biological information read as the input information (biological information on the to-be-authenticated user) against the biological information determined as the check target information (biological information on the users carrying the nearby terminals). Thereafter, the MFP 10 performs operations according to the authentication result of the biometric authentication (steps S17 to S19).

Also, in the second embodiment, the following operations are performed in the case where biometric authentication is performed not by the authentication server 90, but by the MFP 10.

Specifically, the biological information management table 300 (FIG. 4) is stored in the MFP 10, and the determination unit 82, the authentication processing unit 83, and the list generator 84 (FIG. 12) of the authentication server 90 according to the second embodiment are provided in the MFP 10. Then, the MFP 10 performs processing for generating the user designation list 400 (see steps S42 and S43 in FIG. 14) and biometric authentication through one-to-one authentication processing (see steps S45 and S46 in FIG. 14).

More specifically, in the case where nearby terminals have been detected by the detection processing for detecting nearby terminals (step S12), the MFP 10 performs the same processing as that of step S42 (FIG. 14), instead of the processing of step S14 (FIG. 13). To be specific, the MFP 10 identifies the user(s) of at least one mobile terminal 50 each detected as a nearby terminal on the basis of the terminal ID(s) of the at least one mobile terminal 50. Then, the MFP 10 generates, as the user designation list 400, a user list consisting of the user(s) of the at least one mobile terminal 50 among a plurality of registered users. On the other hand, in the case where no nearby terminals have been detected by the detection processing for detecting nearby terminals (step S12), the MFP 10 performs the same processing as that of step S43 (FIG. 14). To be specific, the MFP 10 generates, as the user designation list 400, a user list consisting of all users who belong to one group (selected group) selected in accordance with the operation made through the group selection screen 220 (FIG. 9) among a plurality of registered users.

Then, the MFP 10 displays the generated user designation list 400 on the touch panel 25 (step S38 in FIG. 13) and performs the same processing as that of step S45 (FIG. 14), instead of the processing of step S39. Specifically, the MFP 10 determines biological information on one user (designated user) designated in accordance with the operation made through the user designation list 400, as the check target information for one-to-one authentication. Thereafter, the MFP 10 performs the same processing as that of step S46 (biometric authentication through one-to-one authentication) and performs operations according to the authentication result of the biometric authentication (steps S17 to S19).

In this way, biometric authentication may be performed not by the authentication server 90, but by the MFP 10.

### 3-3. Other Variations

Moreover, in each embodiment and variation described above, nearby terminals are detected on the basis of radio waves for BLE communication emitted from each mobile terminal 50, but the present invention is not limited to this, and conversely, radio waves for BLE communication emitted from the MFP 10 may be used as a basis to detect nearby terminals.

Specifically, the MFP 10 emits radio waves for BLE communication in response to biometric authentication on a to-be-authenticated user being read by the biological information reader 8 (or at fixed time intervals). In the case where the intensity of radio waves received from the MFP 10 is greater than or equal to a predetermined threshold value TH, each mobile terminal 50 transmits a nearby presence notification indicating that the mobile terminal 50 is present in close proximity to the MFP 10 (biological information reader 8), to the MFP 10. Then, the MFP 10 detects the mobile terminal 50 that has transmitted the nearby presence notification as a nearby terminal.

In this way, nearby terminals may be detected on the basis of the radio waves for BLE communication emitted from the MFP 10.

Also, in each embodiment and variation described above, the above-described operations of the embodiment or variation are performed in the authentication processing that is performed when the MFP 10 is used, but the present invention is not limited to this, and the above-described operations of the embodiment or variation may be performed in the other authentication processing (e.g., authentication processing for entry in an entrance and exit management system).

Although embodiments of the present invention have been described and illustrated in detail, it is clearly understood that the same is by way of illustration and example only and not limitation, the scope of the present invention should be interpreted by terms of the appended claims.

What is claimed is:

1. An authentication system for performing biometric authentication through one-to-many authentication, comprising:
a biological information reader that reads biological information on a to-be-authenticated user as input information for the one-to-many authentication;
a detector that detects a nearby terminal among a plurality of mobile terminals carried respectively by a plurality of users, the nearby terminal being a mobile terminal present in close proximity to the biological information reader; and
a hardware processor that determines at least one piece of biological information among a plurality of pieces of biological information registered in advance as candidates for check target information for the one-to-many authentication, as the check target information, the at least one piece of biological information being registered in association with each user of at least one mobile terminal each detected as the nearby terminal, and the check target information being information targeted for check processing for checking against the input information for the one-to-many authentication.

2. The authentication system according to claim 1, wherein
the detector performs detection processing for detecting the nearby terminal in response to the biological information on the to-be-authenticated user being read by the biological information reader, and
the hardware processor determines, as the check target information, the at least one piece of biological information registered in association with the each user of the at least one mobile terminal, each detected as the nearby terminal by the detection processing, among the plurality of pieces of biological information.

3. The authentication system according to claim 1, wherein
the detector performs detection processing for detecting the nearby terminal at a fixed time interval, and
the hardware processor determines, as the check target information, the at least one piece of biological information registered in association with the each user of the at least one mobile terminal, each detected as the nearby terminal by latest detection processing out of the detection processing, among the plurality of pieces of biological information.

4. The authentication system according to claim 1, wherein
the plurality of pieces of biological information is classified into a plurality of groups,
the authentication system further includes:
a display that displays a group selection screen in a case where the nearby terminal is not detected, the group selection screen being a screen that receives an operation of selecting a group to which the to-be-authenticated user belongs from among the plurality of groups, and
wherein, in a case where the nearby terminal is not detected, the hardware processor determines, as the check target information, biological information on users who belong to one group selected in accordance with an operation made through the group selection screen among the plurality of pieces of biological information.

5. The authentication system according to claim 1, wherein
the hardware processor determines, as the check target information, the at least one piece of biological information registered in association with the each user of the at least one mobile terminal, on condition that the to-be-authenticated user is confirmed to carry the mobile terminal by making inquiry at the to-be-authenticated user.

6. The authentication system according to claim 1, wherein
the biological information reader and the detector are provided in an image processing apparatus in the authentication system,
the hardware processor is provided in a server device in the authentication system, and
the biometric authentication is performed by the server device.

7. The authentication system according to claim 1, wherein
the biological information reader, the detector, and the hardware processor are provided in an image processing apparatus in the authentication system, and
the biometric authentication is performed by the image processing apparatus.

8. The authentication system according to claim 1, wherein
the biometric authentication includes at least one of fingerprint authentication, vein authentication, facial authentication, pulse authentication, and iris authentication.

9. An authentication system for performing biometric authentication through one-to-one authentication, comprising:
a biological information reader that reads biological information on a to-be-authenticated user as input information for the one-to-one authentication;
a detector that detects a nearby terminal among a plurality of mobile terminals carried respectively by a plurality of users, the nearby terminal being a mobile terminal present in close proximity to the biological information reader; and
a hardware processor that generates a user designation list that is a user list used to designate one user who corresponds to check target information that is information targeted for processing for checking against the input information for the one-to-one authentication,
wherein the hardware processor generates, as the user designation list, a user list consisting of each user of at least one mobile terminal, each detected as the nearby terminal, among a plurality of registered users in the authentication system.

10. The authentication system according to claim 9, wherein
the detector performs detection processing for detecting the nearby terminal in response to the biological information on the to-be-authenticated user being read by the biological information reader, and
the hardware processor generates, as the user designation list, a user list consisting of the each user of the at least one mobile terminal, each detected as the nearby terminal by the detection processing, among the plurality of registered users.

11. The authentication system according to claim 9, wherein
the detector performs detection processing for detecting the nearby terminal at a fixed time interval, and
the hardware processor generates, as the user designation list, a user list consisting of the each user of the at least one mobile terminal, each detected as the nearby terminal by latest detection processing out of the detection processing, among the plurality of registered users.

12. The authentication system according to claim 9, wherein
the plurality of registered users is classified into a plurality of groups,
the authentication system further includes:
a display that display a group selection screen in a case where the nearby terminal is not detected, the group selection screen being a screen that receives an operation of selecting a group to which the to-be-authenticated user belongs from among the plurality of groups, and
wherein, in the case where the nearby terminal is not detected, the hardware processor generates, as the user designation list, a user list consisting of users who belongs to one group selected in accordance with an operation made through the group selection screen among the plurality of registered users.

13. The authentication system according to claim 9, wherein
the hardware processor generates, as the user designation list, a user list consisting of the each user of the at least one mobile terminal each detected as the nearby terminal, on condition that the to-be-authenticated user is confirmed to carry the mobile terminal by making inquiry at the to-be-authenticated user.

14. The authentication system according to claim 9, wherein
the biological information reader and the detector are provided in an image processing apparatus in the authentication system,
the hardware processor is provided in a server device in the authentication system, and
the biometric authentication is performed by the server device.

15. The authentication system according to claim 9, wherein
the biological information reader, the detector, and the hardware processor are provided in an image processing apparatus in the authentication system, and
the biometric authentication is performed by the image processing apparatus.

16. The authentication system according to claim 9, wherein
the biometric authentication includes at least one of fingerprint authentication, vein authentication, facial authentication, pulse authentication, and iris authentication.

17. An authentication control device for use in an authentication system for performing biometric authentication through one-to-many authentication, the authentication control device comprising:
a hardware processor that acquires biological information that is regarding a to-be-authenticated user and that is read by a biological information reader as input information for the one-to-many authentication, identifies each user of at least one mobile terminal, each detected as a nearby terminal by detection processing for detecting the nearby terminal that is a mobile terminal present in close proximity to the biological information reader, among a plurality of mobile terminals carried respectively by a plurality of users, and determines check target information that is information targeted for processing for checking against the input information for the one-to-many authentication,
wherein the hardware processor determines, as the check target information, at least one piece of biological information that is registered in association with the each user of the at least one mobile terminal, each detected as the nearby terminal, among a plurality of pieces of biological information registered in advance as candidates for the check target information for the one-to-many authentication.

18. An authentication control device for use in an authentication system for performing biometric authentication through one-to-one authentication, the authentication control device comprising:
a hardware processor that acquires biological information that is regarding a to-be-authenticated user and that is read by a biological information reader as input information for the one-to-one authentication, identifies each user of at least one mobile terminal, each detected as a nearby terminal by detection processing for detecting the nearby terminal that is a mobile terminal present in close proximity to the biological information reader, among a plurality of mobile terminals carried respectively by a plurality of users, and generates a user designation list that is a user list used to designate one user who corresponds to check target information that is information targeted for processing for checking against the input information for the one-to-one authentication,
wherein the hardware processor generates, as the user designation list, a user list consisting of the each user of the at least one mobile terminal each detected as the nearby terminal among a plurality of registered users in the authentication system.

19. A method of controlling an authentication control device for use in an authentication system for performing biometric authentication through one-to-many authentication, the method comprising:
a) acquiring biological information that is regarding a to-be-authenticated user and that is read by a biological information reader as input information for the one-to-many authentication;
b) identifying each user of at least one mobile terminal, each detected as a nearby terminal by detection processing for detecting the nearby terminal that is a mobile terminal present in close proximity to the biological information reader, among a plurality of mobile terminals carried respectively by a plurality of users; and
c) determining check target information that is information targeted for processing for checking against the input information for the one-to-many authentication,
wherein in the step c), at least one piece of biological information that is registered in association with the each user of the at least one mobile terminal, each detected as the nearby terminal, among a plurality of pieces of biological information registered in advance as candidates for the check target information for the one-to-many authentication is determined as the check target information.

20. A method of controlling an authentication control device for use in an authentication system for performing biometric authentication through one-to-one authentication, the method comprising:
a) acquiring biological information that is regarding a to-be-authenticated user and that is read by a biological information reader as input information for the one-to-one authentication;
b) identifying each user of at least one mobile terminal. each detected as a nearby terminal by detection processing for detecting the nearby terminal that is a mobile terminal present in close proximity to the biological information reader, among a plurality of mobile terminals carried respectively by a plurality of users; and
c) generating a user designation list that is a user list used to designate one user who corresponds to check target information that is information targeted for processing for checking against the input information for the one-to-one authentication,
wherein in the step c), a user list consisting of the each user of the at least one mobile terminal each detected as the nearby terminal among a plurality of registered users in the authentication system is generated as the user designation list.

21. A non-transitory computer-readable recording medium that records a program for causing a computer to execute the control method according to claim 19, the computer controlling the authentication control device.

22. A non-transitory computer-readable recording medium that records a program for causing a computer to perform the control method according to claim 20, the computer controlling the authentication control device.
